(19) United States
(12) Patent Application Publication
(10) Pub. No.: US 2012/0028707 A1
(43) Pub. Date: Feb. 2, 2012

(54) GAME ANIMATIONS WITH MULTI-DIMENSIONAL VIDEO GAME DATA

(75) Inventors: Bay Leaf Raitt, Carnation, WA (US); Joseph Eddy Demers, Seattle, WA (US); Yahn William Bernier, Seattle, WA (US); Brian Ratcliff Jacobson, Seattle, WA (US); Marc Sean Scaparro, Bellevue, WA (US); Karl Ian Whinnie, Issaquah, WA (US)

(73) Assignee: Valve Corporation, Bellevue, WA (US)

(21) Appl. No.: 13/034,652

(22) Filed: Feb. 24, 2011

Related U.S. Application Data
(60) Provisional application No. 61/308,070, filed on Feb. 25, 2010.
(60) Provisional application No. 61/307,765, filed on Feb. 24, 2010.
(60) Provisional application No. 61/307,781, filed on Feb. 24, 2010.

(51) Int. Cl. A63F 13/00

(52) U.S. Cl. 463/31

(57) ABSTRACT

Embodiments are directed to recording and editing of video game world data obtained from execution of a video game sequence. An animation editor records the game world data within a plurality of data logs after execution of an animation component of the video game and prior to providing the data to a material system and/or graphics device for rendering. The user may edit the recorded data to make changes in the recorded game sequence by replacing at least a portion of the recorded data during a selected time segment. The user may identify a fade-in portion and/or fade-out portion of the time segment over which the subject animation data and the recorded data are to be blended to create a seamless transition. In one embodiment, the added data and the recorded data may be combined using a cross-fading approach.

This application is a utility patent application based on U.S. Provisional Patent Application, Ser. No. 61/307,765, filed on Feb. 24, 2010, the benefit of which is hereby claimed under 35 U.S.C. §119(e), and is related to U.S. Provisional Patent Application, Ser. No. 61/308,070, filed Feb. 25, 2010. Both Provisional Patent applications in their entirety are incorporated by reference herein.

### FIELD OF THE INVENTION

The present disclosure relates to virtual environment systems, and in particular, but not exclusively, to a system and method for acquiring and editing multi-dimensional video game data that is useable to manage video game animations.

### BACKGROUND

Motion capture is a mechanism often used in the movie recording industry for recording movement and translating the movement onto a digital model. In particular, in the movie industry, motion capture involves recording of actions of human actors and using that recorded information to animate a digital character model in 3-dimensional (3D) animation.

In a typical motion capture session, an actor may wear recording devices, sometimes called markers, at various locations on their body. A computing device may then record motion from changes in a position or angle between the markers. Acoustic, inertial, LED, magnetic and/or reflective markers may be used to obtain the changes. This recorded data may then be mapped to a 3D animation model so that the model may then perform the same actions as that of the actor. Often, camera movements can also be motion captured so that a virtual camera in the scene may pan, tilt, or perform other actions, to enable the animation model to have a same perspective as the video images from the camera.

While motion capture does provide rapid or even real time results, motion capture also has several disadvantages. For example, motion capture often requires reshooting of a scene when problems occur. Moreover, because live actors are used, movements that might not follow the laws of physics generally cannot be motion captured. Moreover, where the computer model has different proportions to that of the actor, the captured data might result in unacceptable artifacts due to recording intersections of data, or the like. Therefore, it is with respect to these considerations and others that the present invention has been made.

### BRIEF DESCRIPTION OF THE DRAWINGS

Non-limiting and non-exhaustive embodiments of the present invention are described in reference to the following drawings. In the drawings, like reference numerals refer to like parts through all the various figures unless otherwise explicit.

For a better understanding of the present disclosure, a reference will be made to the following detailed description, which is to be read in association with the accompanying drawings, wherein:

FIG. 1 is a block diagram of one embodiment of a system in which the present invention may be employed;

FIG. 2 is a block diagram of one embodiment of a network device that may be used for recording and/or editing of multi-dimensional video game world data;

FIG. 3 is a block diagram illustrating one embodiment of a relationship between various components within the network device of FIG. 2 that are useable for at least capturing a plurality of components of a video game world within a recorded video game sequence, modifying at least some of the captured components, and feeding the modifications into the video game and/or a material system for use in modifying a display of the video game sequence;

FIG. 4 is one embodiment of non-limiting, non-exhaustive examples of a plurality of components of a video game world;

FIG. 5 is a non-limiting example of one embodiment of a video game display illustrating a recording sequence of one joint component;

FIG. 6 is a flow diagram illustrating one embodiment of an overview of a process useable for recording and editing multi-dimensional video game world data;

FIG. 7A shows one embodiment of an example facial expression of happiness;

FIG. 7B shows one embodiment of an example facial expression of sadness;

FIG. 8A illustrates one embodiment of a set of parameters useable for configuring facial expressions;

FIG. 8B illustrates one embodiment of an example expression vector;

FIG. 9A illustrates one embodiment of a function curve (f-curve) and a corresponding expression parameter;

FIG. 9B illustrates one embodiment of multi-dimensional game world data editing employing fade-in and fade-out time segments;

FIG. 9C illustrates one embodiment of a result of multi-dimensional editing shown in FIG. 6B;

FIG. 10 illustrates one embodiment of cross-fade lines;

FIG. 11A illustrates one embodiment of an expression for computing a composite expression vector;

FIG. 11B illustrates one embodiment of a computing sequence of composite expression vectors;

FIG. 12A illustrates a logical flow diagram generally showing one embodiment of an overview process for editing animation data using multi-dimensional game world data ; and

FIG. 12B illustrates a logical flow diagram generally showing one embodiment of an overview process for computing composite expression vectors for editing of multi-dimensional game world data.

### DETAILED DESCRIPTION

The present disclosure will now be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

As used herein, the term “motion capture” refers to a process of recording movement of a live actor, and translating that movement into a digital model. A used herein, the term “animation motion capture” refers to a process of recording movement and other components of a video game world for later use in re-computing a game state for playing and/or editing. Thus, animation motion capture is directed at overcoming at least some of the disadvantages of live motion capture involving a live actor, including, for example, being constrained by the laws of physics, an inability to modify a viewer's perspective of the video game world during a ‘playback,’ as well as other constraints that are discussed further below.

As used herein, the term “character” refers to an object or a portion of an object that has multiple visual representations in an animation or animation frame. Examples of characters include a person, animal, hair of a character, an object such as a weapon held by a person, clothes various anthropomorphized objects, or the like. A character has a visual representation on a computer display device. However, a character may have other representations, such as numeric, geometric, or a mathematical representation.

As used herein, the term “game,” or “video game” refers to an interactive sequence of images played back in time with audio to create a non-linear activity for the player. As used herein, the term “movie” refers to a fixed sequence of images played back in time with audio to create a linear narrative experience.

As used herein, the term “sequence” refers to a subset of a movie, that includes shots. Further, a sequence may be associated with a particular level.

As used herein, the term “level” refers to a virtual world as experience by a player of the game, usually including, for example, puzzles or objectives. A level may be composed of 3D representations of a sky, ground, ocean, buildings, plants, characters, sounds, or the like.

As used herein, the term “shot” refers to a subset of a sequence. Each shot includes a minimum of a time duration and a camera to view a game world. A shot further includes all the components in a scene, including, for example, characters, motions, and the like, as described further below. As used herein, the term “clip” refers to a shot.

As used herein, the term “time selection” refers to a duration of time. In one embodiment, the user may select a range of time within a shot over which to apply a modification of recorded animation. In one embodiment, a user can make an irregular motion, smooth by selecting the time selection and applying a smoothing operation. A time selection may also have fade in and fade out regions before and after the specified time selection to help create smooth transitions to/from the effected time region. This is referred to herein as time selection falloff.

As used herein, the term “animation” refers to a sequence of data that describes change over time of one or more images. The animation may be stored in a set of data formats within a plurality of distinct data logs such as Booleans (for components of the animation such as visibility, events, particles, or the like); integers (for components of the animation such as texture assignments or the like); floats (for components of the animation, such as light brightness or the like); vectors (for components of the animation, such as colors of the like); or quaternions (for transforms, or the like). Each data has a corresponding time that is then used to create a corresponding visual representation by evaluating the data at that time stamp and connecting various display components, such as those described further below.

As used herein, the terms “subject animation data” or “subject animation sequence” refer to recorded multi-dimensional game world data that is to be edited and/or transformed in some manner, such as described further below. The term “resultant animation data” or “resultant animation sequence” as used herein, refers to that modified multi-dimensional game world data that results from performing the editing process as disclosed below. For example, subject animation data showing an animated character smiling may be edited and/or transformed to create resultant animation data wherein the animated character is shown to change from smiling to frowning. Subject animation data and resultant animation data are generally represented by one or more animation frames. It should be understood, that while one example of editing of multi-dimensional game world data disclosed below involves modifying a facial characteristic, the invention is not limited to merely editing such multi-dimensional game world data, and other multi-dimensional game world data may also be modified, using similar techniques.

As used herein, the term “replacement animation data” refers to a sample of one or more frames of multi-dimensional game world data obtained by a user for use in editing the subject animation data to create the resultant animation data. The replacement animation data may generally be blended with or used to replace at least a portion of the subject animation data to create the resultant animation data.

The terms “fade-in and/or fade-out portion,” and “fade-in and/or fade-out time segment,” as used herein, refer to a leading portion and a trailing portion of a selected time segment of the subject animation data within the multi-dimensional game world data. For example, if the selected time segment is 10 seconds long, then a fade-in portion of the selected time segment may be three seconds long and the fade-out portion of the selected time segment may be two seconds long resulting in three distinct portions of the selected time segment: the fade-in portion, a middle portion, and the fade-out portion. It should be noted, however, that the above example is not to be construed as limiting. Thus, a selected time segment may be other values, as may be fade-in portions and/or fade-out portions.

As used herein, the terms “log” or “data log” refer to a collection of time value pairs used to store animation data. As described further below, the animation data is stored in a plurality of distinct data logs, such that a data log may correspond to a given frame within the animation.

As used herein, the term “frame” refers to a single visual representation of an image within a sequence of images. Thus, in one embodiment, an animation is represented by a sequence of frames.

As an example, then, a movie includes sequences. The sequence includes shots, which in turn includes frames. A frame then may be made by combining the game world data and, if available, any recorded data, which in turn is fed into a material system and associated hardware for display to a user.

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

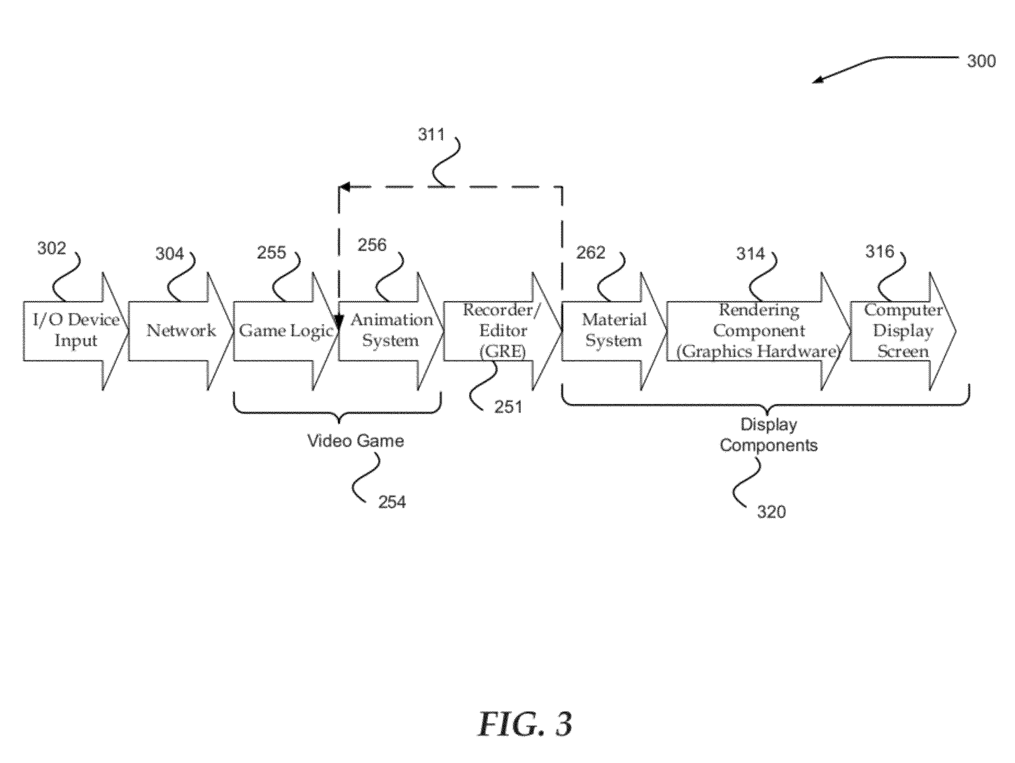

Briefly stated, the present disclosure is directed towards providing an integrated video game and editing system for recording multi-dimensional game world data that may be subsequently edited and fed back into a video game for modifying a display of a video game sequence. The multi-dimensional game world data is recorded at a sufficiently early stage (or upstream of lower level rendering and output primitives) during execution of a video game such that a plurality of multi-dimensional video game world data components are recorded and made available for later editing. In one embodiment, the recording of the game world data is obtained from output of an animation system component of the video game, as described in more detail below in conjunction with FIG. 3.

In one embodiment, the recorded multi-dimensional game world data represents a plurality of components of the game world such as motion data, state data, logical and/or physical physics data including collision data, events, character data, or the like. The recorded multi-dimensional game world data however, might not be directly useable to render an animated image for display. Instead, the recorded multi-dimensional game world data is arranged to be fed into a material system that is configured to perform such pre-rendering activities such as occlusion analysis, lighting, shading, and other actions upon the output from the video game. The output of the material system may then be rendered for display of a video game image or images (e.g., sequence). In one embodiment, the rendering may be performed using a graphics hardware card or other component of a computing device. By collecting the data used to compute the images rather than the images themselves, or the rendered data of the image, or even inputs to the video game, an editor (e.g., user) is afforded greater flexibility in manipulating or otherwise editing a video game play sequence. Based upon this, the data used to compute the images may be modified using the herein disclosed game recorder/editor (GRE).

In traditional filmmaking, video sequences are based on a sequence of two-dimensional images, such as video clips. When a filmmaker wants to change the image(s) within a video clip, often a regeneration of the video clip is required. That is, a live action filmmaker might have to re-assemble staff, equipment, actors, or the like, to recapture the image(s). For animated movies, the animators would have to start over again, as well, by replaying, modifying, rendering, and then re-recording the video sequence of images. In traditional animated movies, and/or live action filmmaking, the process of re-doing a video sequence can be expensive.

Unlike traditional approaches, the disclosed integrated video game and editing system fundamentally shifts the foundation of filmmaking away from two-dimensional video clips, and instead records data for a plurality of multi-dimensional game world components that may then be fed back into the video game for use in computing data useable for a downstream rendering component to render the video sequence for display on a computer display device. Using the multi-dimensional game world data, an editor may readily add characters, change animations, move camera perspectives, and the like, for a video sequence, without having to completely recreate the video sequence. Such approaches would not be feasible, for example, where the recorded sequence represents a streamed video sequence of images, or even data used by a rendering component to render the video sequence. Moreover, by recording the data used to compute the images rather than the images themselves, the GRE enables a user to modify a larger variety of details of a video game sequence. Additionally, in one embodiment, such modifications may be fed back into the video game to result in new computations of a video game sequence, thereby taking advantage of the animation system.

As disclosed further herein, in embodiment, subject animation data is selected from the recorded multi-dimensional game world data to represent composite vectors of various expressions, and/or other composite images. For example, in one embodiment, where the multi-dimensional game world data represents facial expressions, the composite vectors may represent a composite of elements of an expression, such as a mouth position, a lip corner position, a cheek position, an eye size, an eyebrow position, or the like.

In one embodiment, a user selects the subject animation data from the recorded multi-dimensional game world data to be edited using the GRE. The user further selects the replacement animation data which is to be copied into and/or used to replace at least a portion of the selected subject animation data. For example, the replacement animation data might be used to replace at least a portion of the recorded subject animation data. In another embodiment, the replacement animation data might be inserted into the subjection animation data at some designated time period.

The user may further identify a time segment of the subject animation data from where the replacement animation data is to be inserted into, or copied over a portion of the subject animation data. In one embodiment, the time segment is equal to the length of the selected replacement animation data. The user may also identify a fade-in portion and/or fade-out portion of the time segment over which the subject animation data and the replacement animation data are to be blended to create a seamless transition between the subject animation data and the inserted/replacement replacement animation data. In one embodiment, the subject animation data and the replacement animation data may be combined using a cross-fading approach as is described in more detail below. However, the invention is not so limited, and other approaches may also be used to blend the selected subject animation data and replacement animation data.

Although the disclosures discussed herein are focused on animations and more particularly on video games, those skilled in the art will appreciate that the systems, devices, and methods described may be output to create other media content, such as comic books, posters, movies, marketing materials, or combination of film and animation, or other applications to generate toys, without departing from the spirit of the disclosure. Moreover, the input may be from virtually any multi-dimensional input, such as simulation systems, architectural visualizations, or the like. Furthermore, the functionality of the invention may also be employed with a non-video game world system, that could include motion capture data and manual animation of characters, objects, events, and the like, for other types of applications e.g., movies, television, webcasts, and the like.

### Illustrative Operating Environment

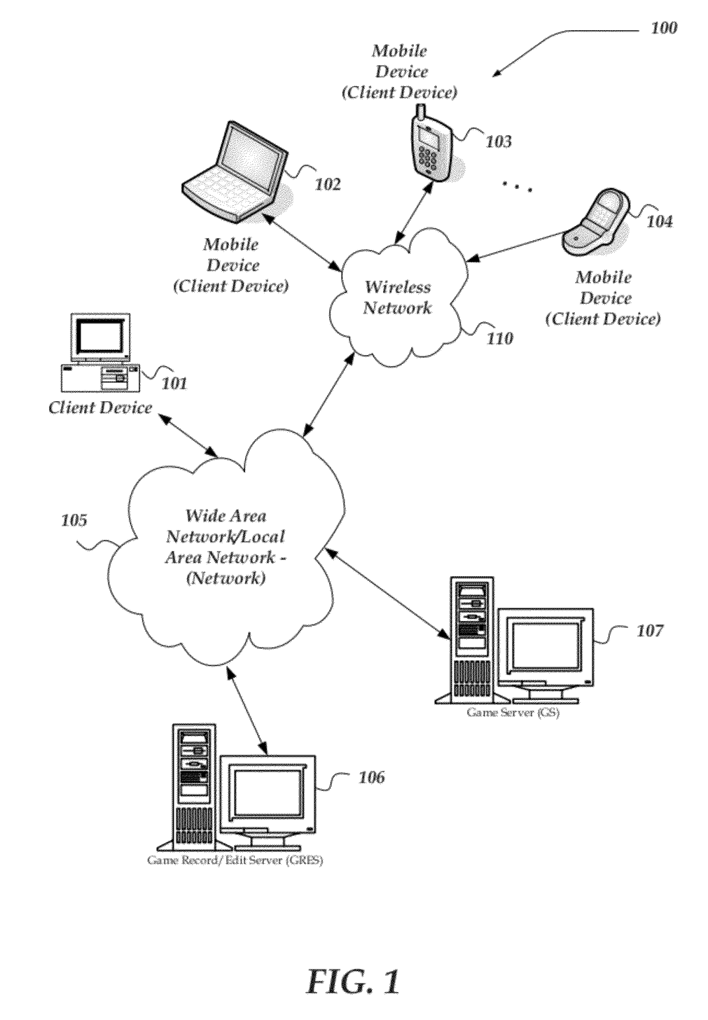

FIG. 1 illustrates a block diagram generally showing an overview of one embodiment of a system in which the present invention may be practiced. System 100 may include many more components than those shown in FIG. 1. However, the components shown are sufficient to disclose an illustrative embodiment for practicing the present invention. As shown in the figure, system 100 includes local area networks (“LANs”)/wide area networks (“WANs”)—(network) 105, wireless network 110, client devices 101-104, Game Record/Edit Server (GRES) 106, and game server (GS) 107.

Client devices 102-104 may include virtually any mobile computing device capable of receiving and sending a message over a network, such as network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information. For example, in one embodiment, the browser may be employed to access and/or play a video game accessible over one or more networks from GS 107 and/or GRES 106.

Client devices 101-104 also may include at least one other client application that is configured to receive content from another computing device. The client application may include a capability to provide and receive textual content, multimedia information, components to a computer application, such as a video game, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to enable a user to request and/or otherwise obtain various computer applications, including, but not limited to video game applications, such as a video game client component, or the like. In one embodiment, the computer application may be obtained via a portable storage device such as a CD-ROM, a digital versatile disk (DVD), optical storage device, magnetic cassette, magnetic tape, magnetic disk storage, or the like. However, in another embodiment, client devices 101-104 may be enabled to request and/or otherwise obtain various computer applications over a network, from such as GRES 106 and/or GS 107, or the like.

Thus, for example, a user of client devices 101-104 might request and receive a computer game application, such as an online computer game, or the like. In one embodiment, the user may have the computer game execute a client management component on one of client devices 101-104 that may then be employed to communicate over network 105 (and/or wireless network 110) with GS 107, GRES 106, and/or other client devices, to enable the gaming experience.

In another embodiment, client devices 101-104 may also be configured to play a video game that is hosted remotely at one or more of GRES 106 and/or GS 107. In one embodiment, client devices 101-104 may further access a game recorder and/or game editor application that may be remotely hosted on GRES 106. Thus, a user of client devices 101-104 may configure a video game for play, and record one or more sequences of video game play using the game recorder. In one embodiment, the game recorder is configured to record multi-dimensional video game world data including, but not limited to a plurality of joints over time for one or more video game characters, objects held by the video game characters, or any of a variety of other video game objects, including trees, vehicles, and the like. The user may also record various data used to generate various background components of the video game sequence, including, but not limited to buildings, mountains, sounds, various environmental data, timing data, collision data, and the like. The user may then use the game editor to edit portions of the recorded multi-dimensional video game world data.

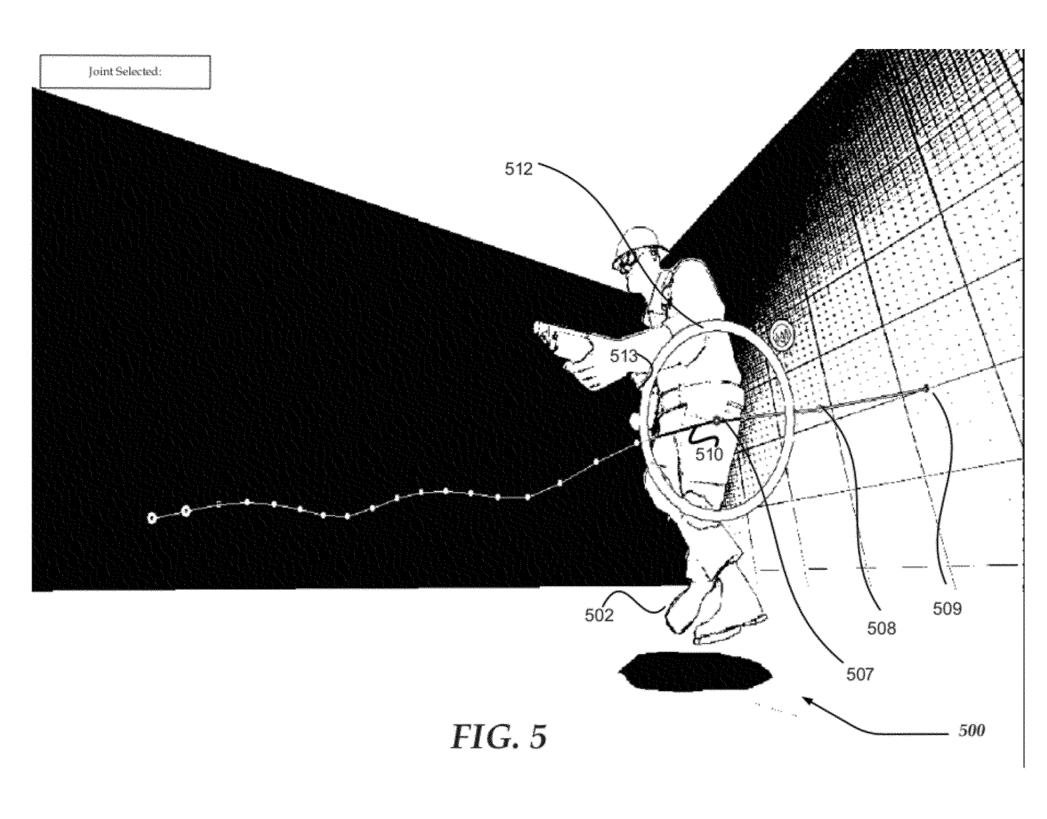

In one embodiment, the user may be provided with a user interface such as described below that is configured to enable the user to select various joints for display using a motion trail. As described further below, the motion trail represents positions, displayed as position indicators, within a computer video game sequence in which a joint may be located within a given frame within the sequence. An example of a motion trail with displayed position indicators is described in more detail in conjunction with FIG. 5 below.

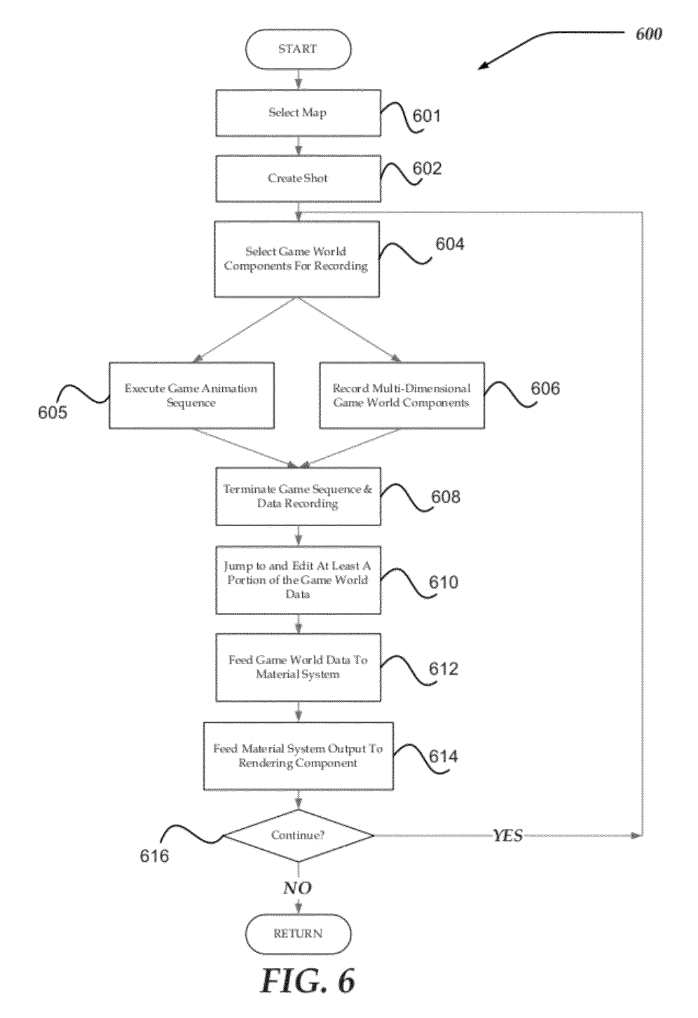

The user may modify the motion trail by replacing position indicators within the motion trail, deleting position indicators, adding new position indicators, and/or dragging position indicators to change a displayed location of the joint for one or more frames within the motion trail. By modifying the motion trail for one or more joints, the user may modify how an animated character within a game might be viewed. Moreover, in one embodiment, because multi-dimensional video game world data is recorded as that data used to compute a given image, rather than the video character image itself, the user may also change a viewing perspective of the animated scene, including the game character. For example, in a first execution and recording of the game, the user might display the game from a perspective of the game character. However, subsequent replaying and/or editing of the game based on the recorded multi-dimensional video game world data, the user may change the perspective to be watching the game character, in a third person perspective. In the third person perspective of the play of the recorded game based on the multi-dimensional video game world data, the user may select any of a variety of different views of the scene. Recording and editing of the recorded multi-dimensional video game world data is described in more detail below in conjunction with FIGS. 5-6.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple GRES 106, GS 107, and client device 101 with other computing devices, including potentially through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

GS 107 may include any computing device capable of connecting to network 105 to manage delivery of components of an application, such as a game application, or virtually any other digital content. In addition, GS 107 may also be configured to enable an end-user, such as an end-user of client devices 101-104, to selectively access, install, and/or execute the application, such as a video game.

GS 107 may further enable a user to participate in one or more online games. Moreover, GS 107 might interact with GRES 106 to enable a user of client devices 101-104 to record and/or edit state data from a video game execution. GS 107 might receive a registration of a user, and/or send the user a list of users and current presence information, such as a user name (or alias), an online/offline status, whether a user is in a game, which game a user is currently playing online, or the like, to client devices 101-104. In at least one embodiment, GS 107 might employ various messaging protocols to provide such information to a user. In one embodiment, GS 107 might further provide at least some of the information through a messaging session to one or more users. Thus, in one embodiment, GS 107 might be configured to receive and/or store various game data, user account information, game status and/or game state information, or the like.

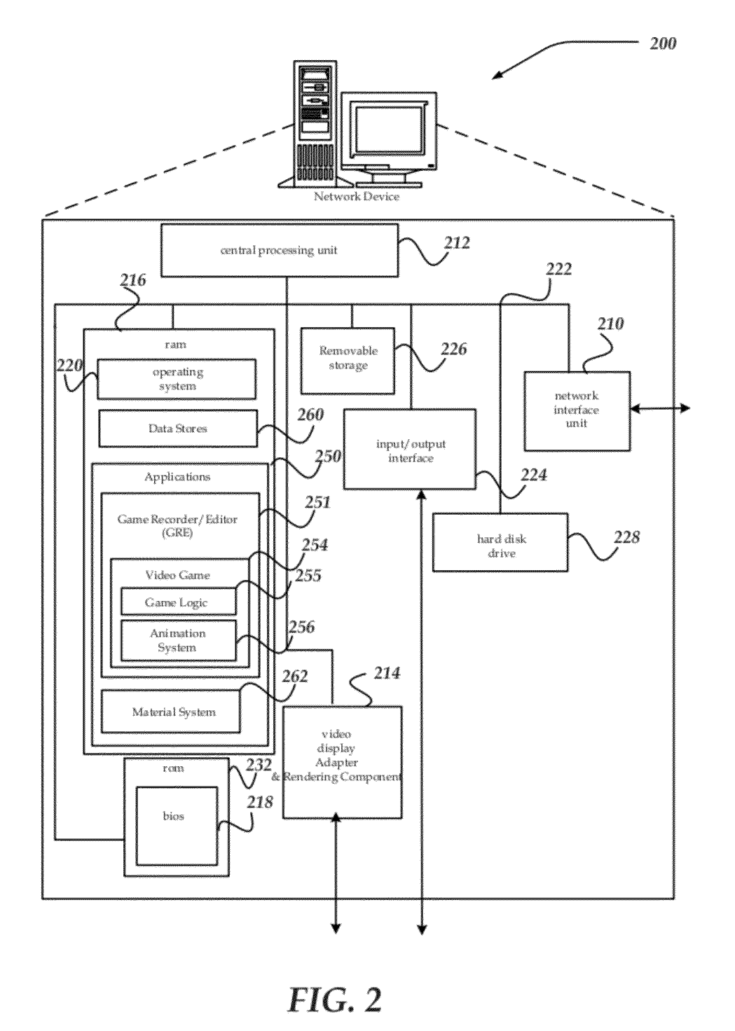

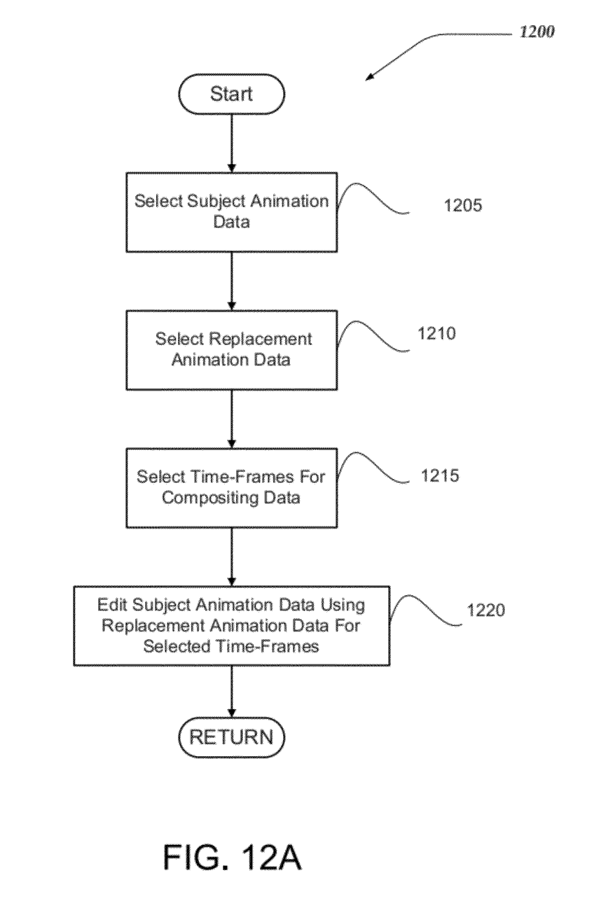

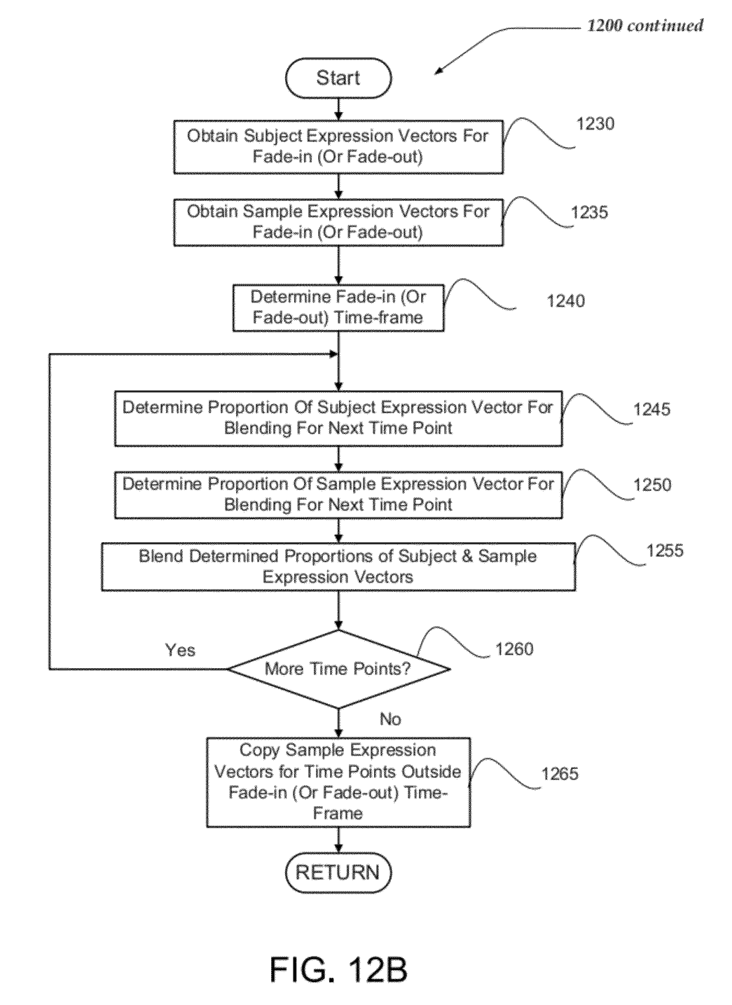

One embodiment of a network device useable for GRES 106 is described in more detail below in conjunction with FIG. 2. Briefly, however, GRES 106 includes virtually any network computing device that is configured to enable a user to record video game state data as multi-dimensional video game world data during an animation motion capture, and to edit such recorded video game data. In one embodiment, GRES 106 may be configured to receive the video game state data from GS 107. In another embodiment, however, GRES 106 may be configured to include a various video game components, such as described in more detail below in conjunction with FIG. 2 to generate and/or play a video game. GRES 106 may record the multi-dimensional video game world data using a flat data structure. However, in another embodiment, the multi-dimensional video game world data may be recorded using a tree structure, a mesh structure, or the like, based on various components of a character, background, and/or other components within the video game world. GRES 106 may further enable a user to edit portions of the multi-dimensional video game world data using process such as described below in conjunction with FIG. 6; and/or FIGS. 12A-12B.

Devices that may operate as GRES 106 and/or GS 107 include personal computers, desktop computers, multiprocessor systems, microprocessor-based or programmable consumer electronics, network PCs, servers, and the like.

Moreover, although GRES 106 and/or GS 107 are described as distinct servers, the invention is not so limited. For example, one or more of the functions associated with these servers may be implemented in a single server, distributed across a peer-to-peer system structure, or the like, without departing from the scope or spirit of the invention. Therefore, the invention is not constrained or otherwise limited by the configuration shown in FIG. 1.

### Illustrative Network Device

FIG. 2 shows one embodiment of a network device, according to one embodiment of the invention. Network device 200 may include many more components than those shown. The components shown, however, are sufficient to disclose an illustrative embodiment for practicing the invention. Network device 200 may represent, for example, GS 107 integrated into GRES 106 of FIG. 1.

Network device 200 includes processing unit 212, video display adapter & rendering component 214, and a mass memory, all in communication with each other via bus 222. The rendering component of video display adapter & rendering component 214 is configured to calculate effects in a video editing file to produce a final video output that may then be displayed on a video display screen. Video display adapter & rendering component 214 may use any of a variety of mechanisms in which to convert an input object into a digital image for display on the video display screen. Network device 200 also includes input/output interface 224 for communicating with external devices, such as a headset, or other input or output devices, including, but not limited, to joystick, mouse, keyboard, voice input system, touch screen input, or the like.

The mass memory generally includes RAM 216, ROM 232, and one or more permanent mass storage devices, such as hard disk drive 228, and removable storage device 226 that may represent a tape drive, optical drive, and/or floppy disk drive. The mass memory stores operating system 220 for controlling the operation of network device 200. Any general-purpose operating system may be employed. Basic input/output system (“BIOS”) 218 is also provided for controlling the low-level operation of network device 200. As illustrated in FIG. 2, network device 200 also can communicate with the Internet, or some other communications network, via network interface unit 210, which is constructed for use with various communication protocols including the TCP/IP protocol, Wi-Fi, Zigbee, WCDMA, HSDPA, Bluetooth, WEDGE, EDGE, UMTS, or the like. Network interface unit 210 is sometimes known as a transceiver, transceiving device, or network interface card (NIC).

The mass memory as described above illustrates another type of computer-readable media, namely computer storage media. Computer-readable storage media may include volatile, nonvolatile, removable, and non-removable media implemented in any method or technology for storage of information, such as computer readable instructions, data structures, program modules, or other data. Examples of computer-readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. In one embodiment, the mass memory may include one or more applications 250 and one or more data stores 260. Data stores 260 include virtually any component that is configured and arranged to store data including, but not limited to user preference data, log-in data, user authentication data, game data, recorded and/or edited multi-dimensional game world data, and the like. Data store 260 also includes virtually any component that is configured and arranged to store and manage digital content, such as computer applications, video games, and the like. As such, data stores 260 may be implemented using a database, a file, directory, or the like.

One or more applications 250 are loaded into mass memory and run on operating system 220 via central processing unit 212. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Applications 250 may also include a Game Recorder/Editor (GRE) 251, and material system 262. As shown, in one embodiment, GRE 251 may include video game 254, which includes various components including, but not limited to game logic 255 and animation system 256.

One embodiment of GRE 251 and video game 254 are described in more detail below in conjunction with FIG. 3. Briefly, however, GRE 251 is configured to enable a user to capture video game data that may subsequently be manipulated (or edited). GRE 251 is configured to provide user interfaces that enable a user to select various aspects of a video game to record and/or edit using animation motion capture of multi-dimensional game world data. As such GRE 251 may interact with video game 254 to enable the user to play a portion of an animated sequence for a game. The user might further interact with video game 254 to modify the animation sequence to be recorded. GRE 251 enables the user to identify what state information is to be recorded as multi-dimensional game world data. For example, the user might select to record virtually every aspect of the animation sequence, including every joint of each character, or other object within the sequence, sounds, coloring, material and/or textual changes, flex weights (which specify a weighting to employ when blending various morph targets) related to changes in a joint, and/or a variety of other information.

GRE 251 may then record the identified state information while the animation sequence is played (executes). During execution of the sequence, the user may manipulate one or more characters and/or objects within the game. For example, in one non-limiting example, the user might select to operate in a first person perspective as one of the game characters, and control the movements of that game character during the recorded game sequence. In another embodiment, one or more other game characters may be controlled, and therefore perform movements based on instructions from video game 254, and/or from another, previously recorded animation sequence.

The user may then employ GRE 251 to replay the game sequence that was recorded using the multi-dimensional game world data. In one embodiment, the user may select to view the recorded game sequence from any of a variety of camera perspectives other than from that of the game character. For example, the user may change camera perspective while the recorded game sequence is being replayed. In one embodiment, the user may record the change to the camera perspective during the recorded game sequence, allowing for subsequent playback to appear to use a different camera perspective.

GRE 251 further provides user interfaces to enable the user to edit the recorded game sequence using a variety of techniques. Because the game sequence is recorded using multi-dimensional game world data obtained as the data used to compute an image, rather than the image itself, the user may make a variety of changes to the recorded game sequence. For example, the user might select to display a frame of the recorded game sequence using the multi-dimensional video game world data to recreate the display of the game. The user may further select for display one or more joints from a plurality of joints that were recorded during the execution of the game sequence. The user may then have overlaid onto the display a motion trail for the joint that represents positions in game space of the selected joint over time. In one embodiment, position indicators, such as circles, dots, or other symbols, may be used to indicate on the motion trail, the joint position in game space for each recorded frame. One non-limiting example of such a motion trail using position indicators is illustrated in FIG. 5.

The user may then employ GRE 251 to select some portion of the motion trail over time From within GRE 251, the user may further edit the motion trail, thereby changing the location of the joint in game space over time. For example, the user might select a position indicator on the motion trail, and drag the position indicator from a first position to a second position. In one embodiment, GRE 251 may smooth transitions between adjacent position indicators to the selected position indicator using a variety of mechanisms, including, but not limited to smoothing the transition between the underlying state data. For example, GRE 251 might automatically relocate adjacent position indicators based on a linear interpolation between position indicators on the motion trail. However, other mechanisms might also be used, including, but not limited to using a spike curve, a dome curve, a bell curve, ease in, ease out, ease in/out or the like, to smooth transitions between position indicators.

In one embodiment, GRE 251 automatically reflects the change in position by displaying in real-time, how the game character associated with the joint might appear in the second position. In one embodiment, the user may play, randomly access, or scrub forward or reverse, the selected sequence with the modification to view how the changed game sequence might now appear.

However, the invention is not limited to merely enabling the user to select and drag one or more position indicators on the motion trail. GRE 251 also enables the user to replace one or more portions of the motion trail with another game sequence, delete portions of the game sequence, insert other game sequences, or any of a variety of other game editing operations. For example, GRE 251 also enables a user to play a recorded game sequence using recorded multi-dimensional video game world data, and to composite one or more other characters onto the recorded game sequence during its execution. The composited game sequence may then be recorded using GRE 251 for subsequent editing using composited multi-dimensional video game world data.

Video game 254 is configured to manage execution of a video game for display at, for example, a client device, such as clients 101-104 of FIG. 1. In one embodiment, components of video game 254 may be provided to the client device over a network. In another embodiment, video game 254 may be configured to execute a video game on network device 200, such that a result of the execution of the video game may be displayed and/or edited at a client device.

Video game 254 includes game logic 255 and animation system 256. However, video game 254 may include more or less components than illustrated. In any event, video game 254 may receive, for example, input events from a game client, such as keys, mouse movements, and the like, and provide the input events to game logic 255. Video game 254 may also manage interrupts, user authentication, downloads, game start/pause/stop, or other video game actions. Video game 254 may also manage interactions between user inputs, game logic 255, and animation system 256. Video game 254 may also communicate with several game clients to enable multiple players, and the like. Video game 254 may also monitor actions associated with a game client, client device, another network device, and the like, to determine if the action is authorized. Video game 254 may also disable an input from an unauthorized sender.

Game logic 255 is configured to provide game rules, goals, and the like. Game logic 306 may include a definition of a game logic entity within the game, such as an avatar, vehicle, and the like. Game logic 255 may include rules, goals, and the like, associated with how the game logic character may move, interact, appear, and the like, as well. Game logic 255 may further include information about the environment, and the like, in which the game logic character may interact. Game logic 255 may also include a component associated with artificial intelligence, neural networks, and the like. As such, game logic 255 represents those processes by which the data found in multi-dimensional game world data are evaluated to be at a correct state for a given moment of the video game world play, including which state should all the game world entities be in, which sound should be played, what score should a player have, what activities are the characters trying to act on, and the like.

Animation system 256 represents that portion of video game 254 that takes output of game logic 255 and poses animated elements in a state suitable for rendering. This includes moving character joints into a position to make it look like they are performing some action, or the like. As such, in one embodiment, animation system 256 may include a physics engine or subcomponent that is configured to provide mathematical computations for interactions, movements, forces, torques, flex weights, collision detections, collisions, and the like However, the invention is not so limited and virtually any physics subcomponent may be employed that is configured to determine properties of entities, and a relationship between the entities and environments related to the laws of physics as abstracted for a virtual environment. In any event, such computation data may be provided as output of animation system 256 for use by GRE 251 as portions of the plurality of multi-dimensional game world data that may be recorded and/or modified.

In one embodiment, animation system 256 may include an audio subcomponent for generating audio files associated with position and distance of objects in a scene of the virtual environment. The audio subcomponent may further include a mixer for blending and cross fading channels of spatial sound data associated with objects and a character interacting in the scene. Such audio data may also be included within the plurality of multi-dimensional game world data provided to GRE 251.

Material system 262 is configured to provide various material aspects to a video input, including, for example, determining a color for a given pixel of a rendered object, or the like. In one embodiment, material system 262 may employ various techniques to create a visual look of game world surfaces to be rendered. Such techniques include but are not limited to shading, texture mapping, bump mapping, shadowing, motion blur, illuminations, and the like.

### Non-Limiting Example of Data Flow Within a Video Game System

FIG. 3 is a block diagram illustrating one embodiment of a relationship between various components within the network device of FIG. 2 that are used to capture a plurality of components of a video game world within a recorded video game sequence, modify at least some of the captured components, and to feed the modifications into the video game and/or a material system for use in modifying a display of the video game sequence. The components illustrated in system 300 of FIG. 3 may be implemented within GS 107 and/or GRES 106 of FIG. 1.

System 300 may include more or less components than those shown. The components shown, however, are sufficient to disclose an illustrative embodiment for practicing the invention. Moreover, while system 300 discloses one embodiment of distributing functions of a video game system across different components, the invention is not to be construed as so limited. Other distributions of functions across components may also be employed. For example, one or more components illustrated may be combined into a single component. Moreover, one or more components might not be employed. For example, network component 304 might not be employed in another embodiment.

However, as illustrated system 300 includes I/O device input 302, network 304, video game 254 that includes game logic 255 and animation system 256, GRE 251, material system 262, rendering component 314, and computer display screen 316, each of which are described in more detail above in conjunction with FIG. 2. For example, rendering component 314 represents the component of video display adapter & rendering component 214 of FIG. 2 that is useable to render an image to computer display screen 316. Similarly, I/O device input 302 represents one embodiment of input/output interface 224 of FIG. 2. Moreover, material system 262, rendering component 314 and computer display screen 316 may collectively be referred to a display components 320.

System 300 is intended to portray one embodiment of a flow of data through the various components for use in managing a video game play. That is, as shown, a user might employ various input devices, such as those described above, to input into various motions, actions, and the like for use by video game 254. For example, in one embodiment, the user might move a mouse; enter data through a keyboard, touch screen, voice system, or the like; move a joystick; or any of a variety of other devices useable to manipulate a game state within a video game sequence. The input from the user is provided through I/O device input 302 over network 304 to video game 254. In one embodiment, such user input may affect various states within the video game, resulting in updates by game logic 255. Game logic 255 provides updates to the video game world state to animation system 256 which in turn is used to pose various characters based on the modified game logic output. As shown, GRE 251 may intercept output from the animation system that includes data for a plurality of multi-dimensional game world components, including data used to compute a character image. By intercepting the data used to compute the character image rather than the image itself, GRE 251 provides a user more flexibility over traditional approaches in modifying a game state sequence.

Output from GRE 251 may be fed back into video game 254, as shown by feedback 311, for revising the image data as represented by the plurality of multi-dimensional game world component data. Output from GRE 251 may also be provided to material system 262 where coloring, shading, and other texturing actions may be performed on the data. The output of material system 262 may then be provided to the rendering component 314 to render the data into an image for display by computer display screen 316.

While GRE 251 is illustrated as capturing output from animation system 256, the invention is not so limited, and GRE 251 may also capture data from other components as well, including, but not limited to I/O device input 302, and/or game logic 255.

Data flow through system 300 may be further described using as a non-limiting, non-exhaustive example, of a “first person shooter” type of game. In this game example, then, while watching computer display screen 316, a user plays the first person shooter game using I/O device input 302 to provide inputs to the game. The user's inputs are then sent through network 304 to game logic 255, which decides if the player hit a target within the game or not. Animation system 256 may then pose a skeleton of a game character, triggers the gunshot sound and starts a particle system within animation system 256. All this information, including outputs from animation system 256 is then recorded by the GRE 251 before being passed to material system 262. Material system 262 upon receiving the data from animation system 256 prepares the scene for the rendering component 314 by adding lights, textures, shaders, and the like, to the scene. All this data is then output back to computer screen 316 for the user to decide whether to shoot again, and/or to perform some other action using I/O device input 302.

After the recording has stopped, the entire experience can be replayed, in one embodiment, by replacing the user's I/O device input 302, network 304 data, and game logic 255 data with the recorded data as fed back using flow 311. Although the experience is now a playback of an GRE recording, it remains representative of the original experience since the data is fed back to the same display systems as the original experience (e.g., components 262, 314 and 316).

### Multi-Dimensional Game World Components

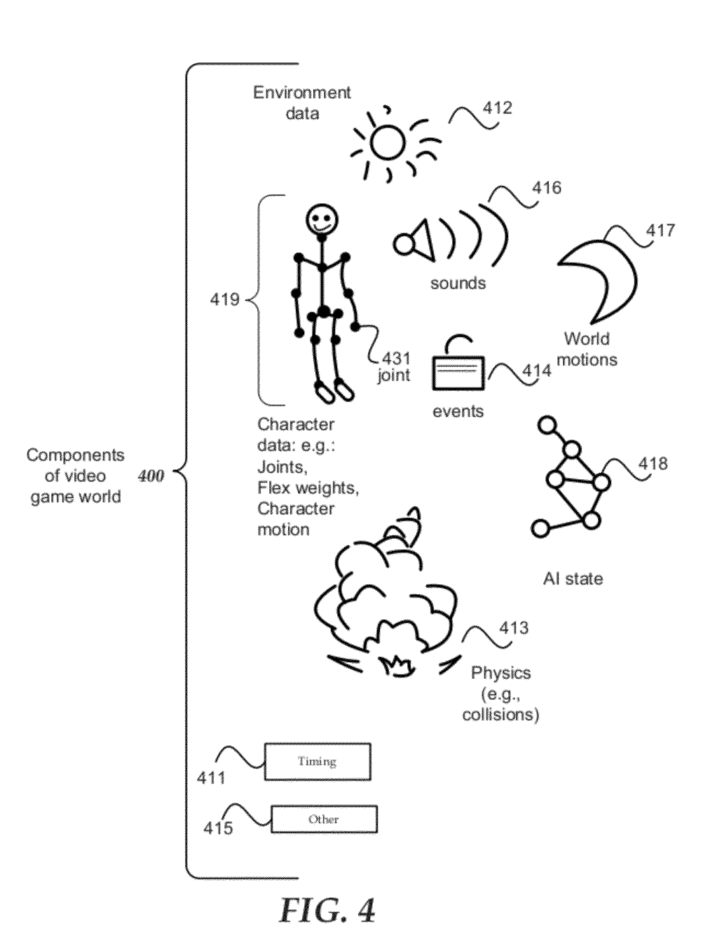

FIG. 4 is one embodiment of non-limiting, non-exhaustive examples of a plurality of components of a video game world for which a plurality of multi-dimensional game world data may be obtained. Components 400 may include many more components than those shown. The components shown, however, are sufficient to disclose an illustrative embodiment for practicing the invention.

Components 400 represents various components of game state data that may be obtained during animation motion capture. The recorded multi-dimensional game world data typically is received from one or more components of a video game during execution of an animated motion sequence. In one embodiment, the multi-dimensional game world data obtained for components 400 includes one or more sets of data such as polygonal mesh data, joint hierarchies, material settings, AI state, particle system data, sound effects, sound triggers, camera placements, and/or virtually any game world state data employable to generate a virtual game world experience. Thus, the components illustrated are not to be construed as limiting, and others may also be used.

In any event, components 400 includes, timing data 411, material/textual changes 412, physics state data 413, visibility data 414, sound data 416, motion data 417, collision data 418, joint data 419, flex weight data 420, and other data 415 associated with the recorded game sequence. The other data 415 may include, but is not limited to wireframe/skeleton data, positional information, motion curve data, or the like. Virtually any data about the game scene over time may be recorded. As such, unlike merely recording triggers and events over time of a game sequence, components 400 represents a dense capture of multi-dimensional game world data, in the sense that a large amount of details about a single component may be collected.

Thus, the multi-dimensional game world data includes not only audio-visual aspects of the scene, but also other information such as wireframe/skeleton of characters and objects, positional information, game states, motion curves and characteristics, object visibility status, start/stop timing of sounds, material changes, state of material, material texture, particle information, physics information, context, and timestamp data, among others.

Besides the data used for creating the images and sounds that are captured, other data dimensions representing game state information such as motion, collision information, wireframe/skeleton data, timestamps, z-order of objects, and other such information may also be captured or extracted and stored for creating the new scene shot in a compositing cycle. The game state information generally includes information about objects and sounds included in the scene, and additionally, information about the scene itself that relate to all objects within the scene, such as scene location and time information.

Thus, such multi-dimensional game world data enables a comprehensive and relatively easy and quick manipulation of objects and characters in the scene using the disclosed animation editor. Moreover, the captured data represented by components 400 may be stored in a file on a computer file system, or alternatively on an external computer-readable medium such as optical disks. In one embodiment, the multi-dimensional game world data represented by components 400 may be initially recorded in a plurality of distinct data logs and then transferred and/or manipulated into another format, structure, or the like.

In one embodiment, components 400 may be implemented in a flat file format such that state data for each frame in the animated game sequence may be separately recorded. That is, the state data for any given frame is complete and independent of another set of state data from any other recorded frame. As such, a scene within the recorded game sequence may be fully recreated from the recorded state data for that frame. In one embodiment, multi-dimensional game world data for each distinct frame may be stored in a distinct or different data log.

### Non-Limiting Video Game Motion Trail

FIG. 5 is a non-limiting, non-exhaustive example of one embodiment of a video game display illustrating a recording sequence for one joint over time using a motion trail. Display 500 may include many more components than those shown. The components shown, however, are sufficient to disclose an illustrative embodiment for practicing the invention. It should be noted that other mechanisms may be used to modify a recorded sequence of a video game play. For example, FIGS. 4-12 provide additional mechanisms using GRE 251 of FIG. 2.

As shown, game character 502 may be illustrated within a given scene, including backgrounds, and the like. In one embodiment, display 500 may represent a single frame from the recorded game sequence, recreated from the recorded multi-dimensional game world data.

Further illustrated is motion trail 510 for a selected joint 507. As seen, motion trail includes a plurality of position indicators, such as 507-509 indicating a location within game space of the selected joint 507 over time. In one embodiment, the motion trail 510 may represent changes of the selected joint 507 over the entire recorded game sequence, each change being recorded as multi-dimensional game world data within a distinct data log for a given frame. However, in another embodiment, motion trail 510 may be a selected subset (e.g., a “time selection”) of the recorded positions of selected joint 507. Motion trail 510 may be drawn onto display 500 to provide the user with a visual cue of transitions between position indicators. Computing motion trail 510 through the recorded positions of joint 507 as represented by the position indicators may be performed using virtually any mechanism.

As further shown, a user may be provided with a selector tool, such as selector ring 512. The user may employ selector ring 512 to select a range of position indicators to manipulate, zoom in/out on, or the like. In one embodiment, selector ring 512 may include a pivot handle 513 useable to rotate, drag, or otherwise further manipulate one or more enclosed position indicators. For example, in one embodiment, selector ring 512 may be centered onto position indicator 507, as shown by the rectangle over position indicator 507. The user may then employ pivot handle 513 to drag position indicator 507 from a first location to a second location, thereby modifying the displayed motion trail 510. As used herein, a “pivot” refers to a point around which a joint may rotate. By default, in one embodiment, the pivot or pivot point is the joint itself, but it can be moved to accommodate more complex rotations.

Thus, as illustrated, a user may select a specified frame based on a selected position indicator 507-509 within a recorded plurality of frames from within the recorded video game sequence that is stored within the plurality of distinct data logs. The user may then edit the sequence using the data log editor and such as described above, to edit at least some of the recorded multi-dimensional game world data within at least one of the distinct data logs for a specified frame range. The user may then send the results to a material system and/or fed back the results of the editing to the animation system, and/or game logic components of the video game system to have the modified sequence displayed for the at least the specified frame range.

It should be noted, however, that the user is not limited to dragging position indicators within a motion trail. For example, the user may also select to delete position indicators, add position indicators, insert within a motion sequence into the recorded game sequence, or the like. Additionally, different types of manipulation may be selected by the user for the motion trail, including: (1) Replacement—an animation is replaced by a non-animated state such as a pose; (2) Transform—an animation is globally modified where the motion trail is shifted without changing the shape of the motion trail; and (3) Offset—an animation that is locally modified and where the motion trail is modified relative to itself.

### Generalized Operation

The operation of certain aspects of the invention will now be described with respect to FIG. 6. FIG. 6 is a flow diagram illustrating one embodiment of an overview of a process useable for recording and editing multi-dimensional game world data. Process 600 of FIG. 6 may be implemented within network device 200 of FIG. 2, in one embodiment.

Process 600 begins, after a start block, at block 601 where a user selects a given map or video game to be played, including a game environment, such as a game scene, and one or more video game characters to be placed within the game scene for executing of a game sequence. Proceeding to block 602, the user may then select or otherwise create a given video sequence to be shot. In one embodiment, the given video sequence may be a subset of the given map selected within block 601. In at least another embodiment, each shot may be created with a separate map, and game world component data can be recorded multiple times into the same shot. Continuing to block 604, the user may further select one or more joints for recording as multi-dimensional game world component data. That is, in one embodiment, the user identifies a plurality of components to be recorded with the video game world of block 601, where each component within the plurality is to be recorded within a distinct frame by frame data log to generate a plurality of different data logs.

In one embodiment, a default configuration may include recording of every joint within the game scene and/or on the game character. Such joints may be predefined during creation of the game character. For example, joints may be defined as pivot points between two ‘hands” of a skeleton structure. However, joints may also be defined by other desirable recording points on an animated structure. For example, for an leg, the joint points might include a knee control, but not be limited to the clothing, shoelaces, hemlines of a skirt, kneepads, or the like. For a vehicle, the joint points might include, but not be limited to several points along a radial arm of a tire, such as an outside point and/or a center point of a tire. Clearly, other joints may be identified than these examples illustrate, and thus the invention is not to be construed as being limited by such examples.

In any event, in one embodiment, the game character may be controlled by the user. That is, the user may provide various inputs using a mouse, keyboard, audio input, a joystick, or the like, to control movement of the game character. Movement of the game character is anticipated in resulting in movement of joints on the game character. In one embodiment, a display of the game sequence may be shown on the user's computer display device. In one embodiment, the game sequence may employ a first person perspective or camera position. That is, in one embodiment, the user may view actions of the game character from the perspective of the game character, in a perspective sometimes known as a first person “shooter” perspective.

Processing flows next to blocks 605 and/or 606 where the user may select to execute the game logic and game animation to enable a display on a computer display device a sequence of movements over a plurality of frames within the video game world. At block 605, in at least one embodiment, the executing of the game animation and game logic may generate game world component data from the game. Also, in at least one embodiment, the game world component data may be imported as a sequence, e.g., copied from game assets in a manner similar to applying animation presets.

In one embodiment, the user may employ the game recorder, described above, to record some or all of the game animation as animation motion capture by recording multi-dimensional game world component data, including the one or more selected joints. That is, in one embodiment, while executing the movements during the video game sequence of the video game, the user records within each of the distinct plurality of different data logs multi-dimensional game world data for the identified plurality of components prior to rendering each frame.

Block 606 may be entered concurrent with block 605, or subsequent to/or even before execution of the game sequence. Moreover, the user may select to stop recording concurrent with, or even before completing execution of the game sequence.

Processing then flows to block 608, where the user may terminate the game sequence and/or the recording of the multi-dimensional game world component data. Processing continues next to block 610, where the user may play back the recorded game sequence using the recorded multi-dimensional game world component data. That is, in one embodiment, the user may perform a jump to a specified frame within the recorded plurality of frames from within the recorded video game sequence stored within the plurality of distinct data logs. As used herein, jumping refers to a process of selecting and accessing a specified frame based on some identifier, such as a time, play sequence identifier, or the like. It should be noted, however, that the user is not limited to proceeding to block 610, and although not illustrated, the user may cycle through blocks 605 and/or 606 as often as desired, before selecting to play back the recorded game sequence. Moreover, the user may also loop back to block 602 and/or 604 to select different scenes, game characters, joints for recording, or the like, without departing from the scope of the invention.

In any event, at block 610, the user may then select one or more portions of the recorded game sequence for editing. That is, using a data log editor such as described above, the user may edit at least some of the recorded multi-dimensional game world data within at least one of the distinct data logs within the plurality of data logs for a specified frame range.

When the game sequence (e.g., movie) is ready to be published and distributed, we save out an image sequence for the entire movie and an associated audio file to be played in sync in commonly found venues, such as on the internet, television, theatres, DVDs, or the like. At this point, the process steps through the movie, frame by frame, constructing the final frame using the logic found in display components 320 in FIG. 3, and then saves the screen output into a single image file, which may then be saved to, such as data stores 260 of FIG. 2, or other computer-readable storage medium.

The user may select any of a variety of editing mechanisms, including, but not limited to compositing the recorded game sequence with another game sequence and/or game characters, inserting a portion of a game sequence into the recorded game sequence, deleting portions of the recorded game sequence, and/or manipulating portions of the game sequence, for example, by modifying portions of a motion trail for a joint. A modification to one or more portions of the motion trail for the joint may include, but are not limited to, orientation, position, and rotation of the joint. As noted, however, the user is not limited to merely these manipulations, and others may also be performed, including modifying a camera perspective of the recorded game state data, for example. Thus, because the present invention is directed towards recording multi-dimensional game world component data that includes that data used for calculating an image rather than the image itself, a plurality of different manipulations may be performed that might not otherwise be available by recording triggers and events from the triggers.

Proceeding to block 612, the user may then have the results of the edits sent to the material system within the network computing device the recorded multi-dimensional game world data within each of the distinct data logs including the at some edited data within at least one of the distinct data logs to display a modified video game sequence for the specified frame range. As noted above, however, the results may also be fed back to the animation system for further updates to the multi-dimensional game world component data. Flowing next to block 614, the output of the material system are further fed to a rendering component, to be rendered as an image displayable on a video device.

Process 600 may then flow to decision block 616, where a determination is made whether to continue recording and editing the multi-dimensional game world component data. If so, then processing loops back to block 604 where the user may further select one or more joints for recording as multi-dimensional game world component data. If process 600 is to be terminated, however, processing then may return to another process to perform other actions.

### Non-Limiting, Illustrative Example of Further Game Animation Editing

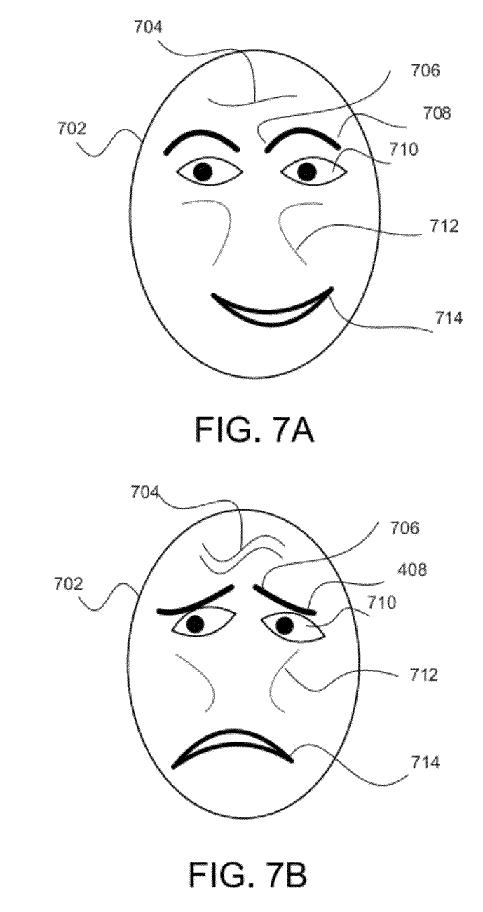

FIGS. 7A and 7B are embodiments of non-limiting, non-exhaustive examples of facial expressions for happiness and sadness, respectively. The data employed to illustrate such facial expressions may be obtained, for example, during 600 of FIG. 6 as multi-dimensional game world component data.

In one embodiment, facial expression for a face 702 may be defined using a number of expression parameters, such as position of eyebrows, lip corners, forehead wrinkles, cheek muscles, and the like. For example, the facial expressions shown in FIGS. 7A and 7B may be defined by a combination of forehead wrinkles 704, inner eyebrow corner 706, outer eyebrow corner 708, opening of eye 710, cheek muscle 712, and lip corner 714. Each expression parameter may be associated with a corresponding facial feature. Additionally, each expression parameter may have a value that may be defined by a position or distance of the corresponding facial feature relative to a defined corresponding local reference frame. For example, in one embodiment, the value of inner eyebrow corner 706 expression parameter may be defined as the distance of the inner eyebrow corner 706 during a facial expression such as sadness, from a position of inner eyebrow corner 706 corresponding to a blank facial expression (showing no particular emotion) when eyebrows are in neutral position (not flexed in any direction). Assigning a position or distance of 0 (zero) to the inner eyebrow corner 706 for a blank facial expression, inner eyebrow corner 706 during a sad facial expression (for example, shown in FIG. 7B) may include assigning a value, for example, 2 or 5 on a predefined scale, such as milk-meters (mm). In another embodiment, a maximum possible distance between a facial feature, corresponding to an expression parameter, and its corresponding local reference frame may be assigned a value of 100%. Smaller values of this parameter may be expressed in terms of a value between 0% and 100%, for example, 37%. In yet another embodiment, the reference frame for a given expression parameter may be assigned a value of 0 while the expression parameter may take on positive and negative values, for example, −2, −5, −32%, +18%, and the like. Similar local reference frames may be defined for any given expression parameter and the corresponding facial feature. The invention, however, is not limited to these example values, and others may also be used.

In one embodiment, a definition of an expression parameter may indicate a type of the value of the expression parameter. The value of the expression parameter may be a distance, an angle, a relative position with respect to another expression parameter (for example, one upper lip/teeth over lower lip, an area (for example, the surface area of an open mouth or eye in an image), and the like. For illustrative purposes and clarity of discussion, expression parameter values discussed herein are assumed to be of type length, distance, or position, but the disclosure is not so limited.

Those skilled in the art will appreciate that the discussions herein regarding facial expressions and corresponding expression parameters apply to multi-dimensional game world data other than facial expressions. For example, the multi-dimensional game world data may represent body pose and posture; subject common behavior patterns, such as walking, jumping, climbing, and the like; common interactions with others such as shaking hands and the like may be represented using combination of positional parameters in a similar manner as expression parameters. For instance, a sitting body pose may be defined using parameters such as position and/or angle of the legs, position of the knees, and the like. Similarly, different body positions and postures during running or climbing may be specified using similar combinations of positional parameters using relevant body parts, such as joints, hands, feet, head, and the like. Also, similar to the expression parameters, the value of the positional parameters may be of different types, such as distance, position, angle, area, relative position, order, and the like, depending on the definition of the positional parameters. Thus, virtually any of the multi-dimensional game world data obtained during process 600 may be employed.

With continued reference to FIGS. 7A and 7B, two facial expressions may share some or all of the expression parameters defining the two facial expressions. However, each facial expression is typically defined by a unique combination of ranges of values of the corresponding expression parameters. For example, both happiness and sadness facial expressions may include the same expression parameters, namely, forehead wrinkles 704, inner eyebrow corner 706, outer eyebrow corner 708, eye opening 710, cheek muscle 712, and lip corner 714. However, each facial expression may be defined by a different combination of the values, or ranges of values, of these expression parameters. For example, the value of lip corner 714 expression parameter for happiness expression may be +60%, measured from a corresponding local reference frame assigned a value of 0%, such as a straight horizontal line between the lips in a blank expression, while the value of lip corner 714 may be −35%, relative to the same local reference frame, for a sadness expression. Those skilled in the art will appreciate that instead of having negative and positive values, the expression parameters may have only positive (or only negative) values, for example, 0% to 100%, with different ranges of values partially defining a particular facial expression in conjunction with other expression parameters that together fully define the particular facial expression. For example, a value range of 0%-40% may partially define one expression while 41%-100% may partially define another expression.

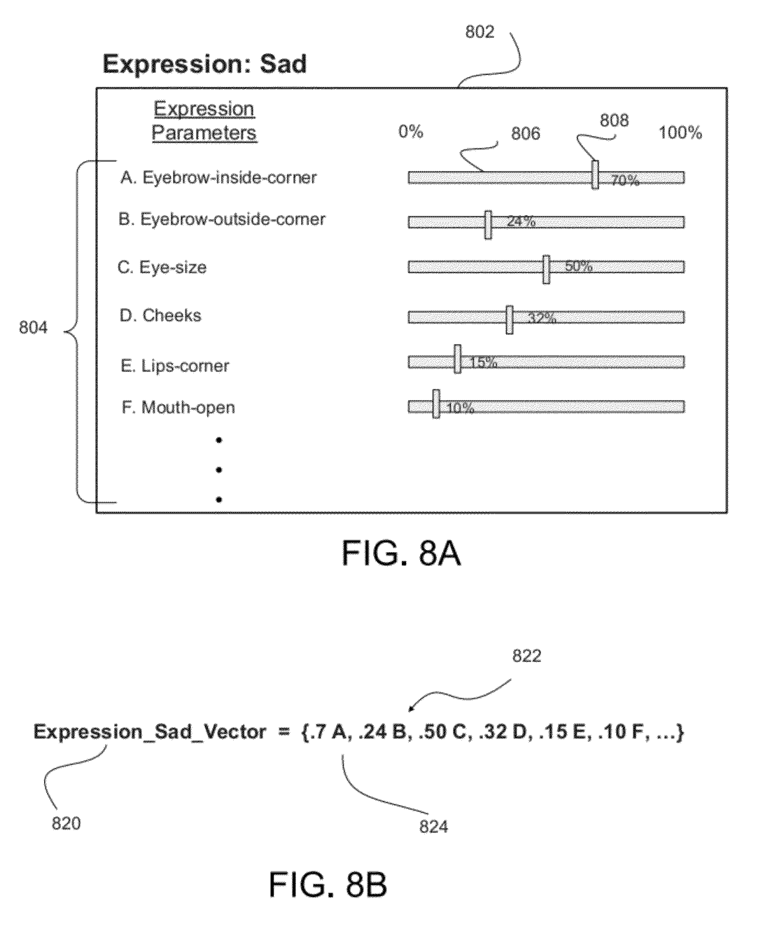

FIG. 8A is an embodiment of a set of parameters for configuring facial expressions. Moreover, interface 802 of FIG. 8A may represent at least one embodiment of a user interface for GRE 251 of FIG. 2 described above that enables a user to modify features of a recorded character, or the like.

Each parameter 804 of the set of parameters shown in FIG. 8A may have a value of a facial expression, such as happiness, sadness, fear, anger, surprise, dismay, and the like, that in combination with the values of other expression parameters specify a particular facial expression. For example, as an interface used in the GRE, expression parameters A-F may each be set to a different value by sliding control 808 over slider 806. In one embodiment, slider 806 represents a value range of 0%-100%. In another embodiment, slider 806 may represent a different type of value ranges, numerical values, or percentages of a maximum value, such as positive numbers, negative numbers, or both, on a subject scale, such as mm, degrees (angle), area, and the like. By changing the proportions of the values of the expression parameters A-F, the facial expressions, represented and/or animated using the expression parameters A-F, change.

In one embodiment, an expression may be defined by a proportion, or range of proportions, of the values of expression parameters A-F. A facial expression, such as happiness, sadness, fear, and the like, may also be assigned an intensity level. For example, in one embodiment, a happiness facial expression may range from 0% happiness (blank expression) to 100% happiness, a maximum intensity that can be visually represented as constrained by natural limits on the movements of human facial features, such as movement/flexing of eyebrows, extent of stretched lips, and the like. In another embodiment, a numerical range may be assigned by an animator to represent lower and upper bounds of a facial expression. In one embodiment, the intensity of a facial expression may be expressed by a particular set of values for the corresponding expression parameters. For example, 60% intensity for facial expression of happiness may be expressed as the set of values of corresponding parameters A-F, including 45%, 30%, 45%, 68%, 62%, and 17%, respectively.

A different intensity, for example 75%, for the same facial expression may be represented by a different set of values, as long as the values in the different set do not exceed a predetermined threshold and/or stay within a predetermined range of values defined for each corresponding expression parameter for the particular facial expression. If one or more values of the corresponding expression parameters fall outside the defined range of values for the particular facial expression, then a different facial expression may be represented. For example, if expression parameter E, lip-corner, is defined to have a range of values between 50% to 100% for facial expression of happiness, and the value is set to 40%, then the facial expression represented may be sadness instead of happiness. Thus, by changing expression parameter values, the facial expression may be transformed from one expression to another.

FIG. 8B is an embodiment of an expression vector that may be employed through the GRE. A particular combination of values of expression parameters forms an expression vector, each vector component of which is a value of a particular expression parameter. An expression vector may he considered, in one embodiment, as an “N-tuple” vector where there is N expression parameter values included in the expression vector. For example, an expression vector of sadness 820 includes a particular combination of values for each of the expression parameters A-F. In one embodiment, a maximum expression vector for a particular facial expression represents the maximum intensity defined for the particular facial expression and includes a combination of expression parameter values that maximizes the intensity of the particular facial expression. In one embodiment, the expression vector may be linear, where a scalar factor between 0 and 1 (or equivalently, between 0% and 100%) may be used to scale the maximum intensity vector to any intensity level for the particular facial expression. In this embodiment, the maximum expression vector is multiplied by a scalar factor to produce an intensity between 0 and the maximum intensity of the particular facial expression.

In another embodiment, the expression vector may be non-linear, where each vector component is controlled in a non-linear fashion in relation to other vector components. In a non-linear expression vector, the relationship between the different vector components may be determined using an associative table or an analytical function. For example, to determine a particular intensity of a particular facial expression, the vector components are set according to entries in an associative table, rather than by multiplying all vector components of a maximum expression vector by a scalar. The associative table may, for example, list various intensity levels of a particular facial expression in one column, and list the corresponding values for each of the expression parameters, that is, the vector components, in other columns, such that one row of the table includes a given intensity level of the particular facial expression and the corresponding vector components for that intensity level.

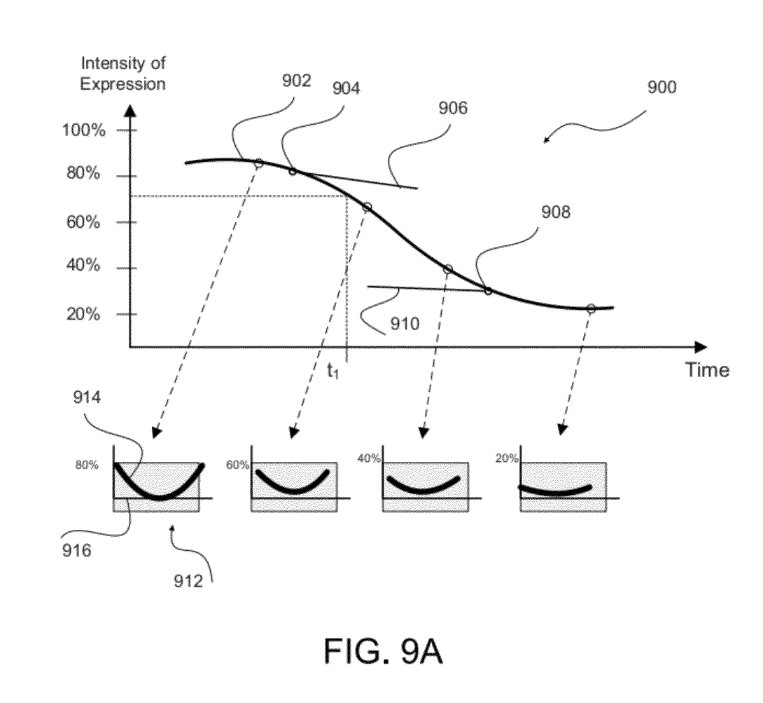

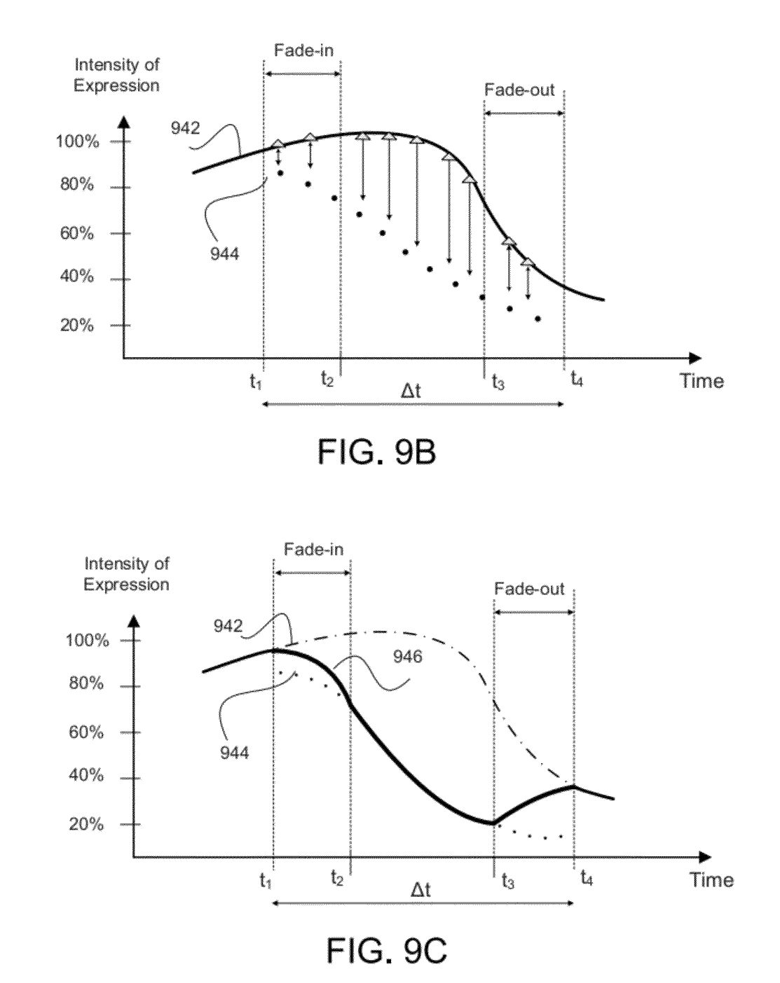

FIG. 9A is an embodiment of an f-curve and a corresponding expression parameter. In one embodiment, f-curve 902 may be a spline curve controlled by knots 904 and 908 and corresponding handles 906 and 910. F-curve 902 may represent changes in a facial expression over time. Each point on f-curve 902 may include a time coordinate, such as t₁, and an intensity coordinate, such as 72%. As noted above, the intensity of a facial expression may be represented by numerical values, positive or negative, or by percentage values. Each point on the f-curve 902 may also be associated with a distinct expression vector, and thus, also with a set of expression parameters. For example, if f-curve 902 represents a happiness facial expression, one point on f-curve 902 may be associated with expression parameter 912, in this example, lip corner 914, along with the other expression parameters that form the expression vectors for the happiness facial expression. At four successive points (shown by dotted arrows), as f-curve 902 falls, the values of the corresponding lip corners 914 also drop, representing a lower intensity of facial expression of happiness represented by f-curve 902. As noted above, the value of lip corner 914 may be measured with respect to a reference frame 916. Other expression parameter values (not shown) may undergo similar changes as f-curve 902 is traversed over time. Those skilled in the art will appreciate that as handles of a spline curve are moved, points on the spline curves between the knots are interpolated to change the shape of the spline curve. Therefore, to edit/change the intensity of a facial expression represented by f-curve 902, handles 906 and 910 may be used to change the shape of f-curve 902 and also all the expression vector component values corresponding to each point on f-curve 902.

FIG. 9B is an embodiment of editing of an animation sequence including fade-in and fade-out within a time segment. In one embodiment, a user may employ the GRE, such as described above in conjunction with FIG. 2 to edit an animation sequence. Thus, in one embodiment, FIGS. 9B-9C may represent a display interface that may be used to edit animation sequences using the recorded multi-dimensional game world data obtained during process 600 of FIG. 6.

As shown in FIG. 9B, is a non-limiting, non-exhaustive example of subject animation data 942 selected from within the recorded multi-dimensional game world data that represents a facial expression that may be edited using replacement animation data 944. In one embodiment, replacement animation data 944 may be obtained from a data store, from another animation sequence, or the like. As shown, a selected time segment Δt=t4−t1, may generally be an area of interest for changing at least a portion of subject animation data 942. The selected time segment Δt may include distinct portions, where each portion is used differently during the process of editing. In one embodiment, the selected time segment Δt may include a fade-in (=t2−t1) and/or a fade-out (=t4−t3) time segment. For example, in an original scene including subject animation data, an animated character may be smiling mildly. In an edited scene, the animator may want to show a less intense smile or happy facial expression, during selected time segment Δt. A GRE may be used to create the edited scene, the resultant animation data, from the original scene. In one embodiment, replacement animation data 944 may be created and stored in a file. In another embodiment, replacement animation data 944 may be created during editing. In yet another embodiment, the replacement animation data 944 may be downloaded from a remote server over a network. The GRE may then be used to combine, for example, by blending, the replacement animation data 942 with the subject animation data 944 to effect a transformation with relatively low computational cost.

In one embodiment, the replacement animation data 944 may be used during the fade-in and/or fade-out time segments to create a gradual transformation with respect to the subject animation data 942 in the original scene. The replacement animation data 944 may be blended with the subject animation data 942 to effect the gradual transformation. During a middle portion of the selected time segment Δt, the time portion outside the fade-in and fade-out portions, replacement animation data 944 may directly replace that least a portion of subject animation data 942, without any blending.

As illustrated, each point on subject animation data 942, and replacement animation data 944, may be associated with a corresponding expression vector. Also, each corresponding expression vector may have a number of vector components (representing expression parameter values) corresponding to the facial expression represented by subject animation data 942 and replacement animation data 944.

Depending on the subject animation data 942, replacement animation data 944, and the desired resultant animation data, the selected time segment Δt may or may not include at least one of a fade-in portion, a fade-out portion, and a middle portion. For example, in one case, if the middle portion is not needed, then replacement animation data 944 may be used through-out the selected time segment spanning fade-in and fade-out portions, which may merge into a single fade-in portion. In such case, subject animation data 942 may be blended with replacement animation data 944 and no direct replacement may take place. In another embodiment, the fade-in or the fade out portion, or both, may not be used and a direct replacement may take place during the entire selected time segment Δt.

FIG. 9C is an embodiment of a result of the editing shown in FIG. 9B. Resultant animation data curve 946 may result from the editing of subject animation data curve 942 using replacement animation data curve 944. During the fade-in and/or fade-out portions of the selected time segment Δt, subject animation data curve 942 is blended with replacement animation data curve 944, as more fully described below, resulting in a portion of resultant animation data curve 946. During the middle portion (=t3−t2) of the selected time frame Δt, resultant animation data curve 946 may fit closely or identically on top of at least a portion of replacement animation data curve 944, because at least a portion of replacement animation data 944 replaces at least a portion of subject animation data 942. Using editing, subject animation data 942 may be transformed into resultant animation data 946.

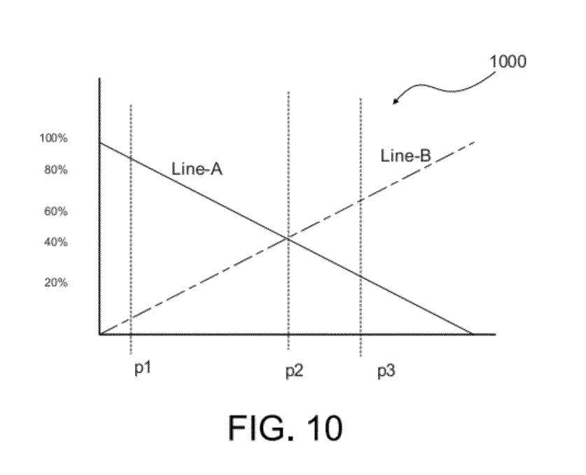

FIG. 10 illustrates one embodiment of cross-fade lines 1000 that are useable in blending fade-in and fade-out animation data for cross-fade proportion and cross-fade complement, such as described above and below. In one embodiment, each point on line-A and a corresponding point on line-B that have equal horizontal coordinates, have vertical coordinates the sum to 100%. For example, at each of points p1, p2, and p3 the sum of the vertical coordinates of corresponding points on line-A and line-B are each equal to 100%. Traversing the cross-fade lines from left to right in FIG. 10, as the vertical coordinate of points on line-A decrease, the vertical coordinate of points on line-A experience a proportional increase to keep the sum at 100%. Therefore, line-A defines a cross-fade proportion and line-B defines a cross-fade complement of line-A, and vice versa. Using the cross-fade lines, the replacement animation data and the subject animation data may be blended in proportion based on values of line-A and line-B at vertical coordinates. For example, line-A vertical coordinates may be used as scalar values for multiplication of replacement animation data and line-B vertical coordinates may be used as scalar values for multiplication of subject animation data, thus blending the two sets of data in increasing and decreasing proportions, respectively. The horizontal axis of cross-fade lines 1000 may be superimposed on time axis shown in FIG. 9B, and at each corresponding point on the time axis the values of the vertical coordinates of line-A and line-B may be multiplied by the corresponding linear expression vectors to effect blending.

In another embodiment cross-fading may be achieved using two curves instead of two lines. As long as the vertical coordinates of the corresponding points on the two curves add up to 100%, cross-fading may be achieved. In the case of lines, the rate of cross-fading over a fade-in or fade-out time segment is linear. In the case of curves, the rate of cross-fading over a fade-in or fade-out time segment is non-linear. In yet another embodiment, multiple cross-fading lines or curves may be used to blend corresponding multiple sets of data. As long as the sum of the vertical coordinates of all corresponding points on the multiple lines or curves is 100%, blending may be achieved. In still another embodiment, the blending of the subject animation data and the replacement animation data over at least a portion of the time segment to transition between a remaining portion of the subject animation data and a replacement portion of the replacement animation data to create resultant animation data may be performed using a variety of other mechanisms, including, but not limited to, a spline interpolation within the fade-in and/or fade-out time segments.

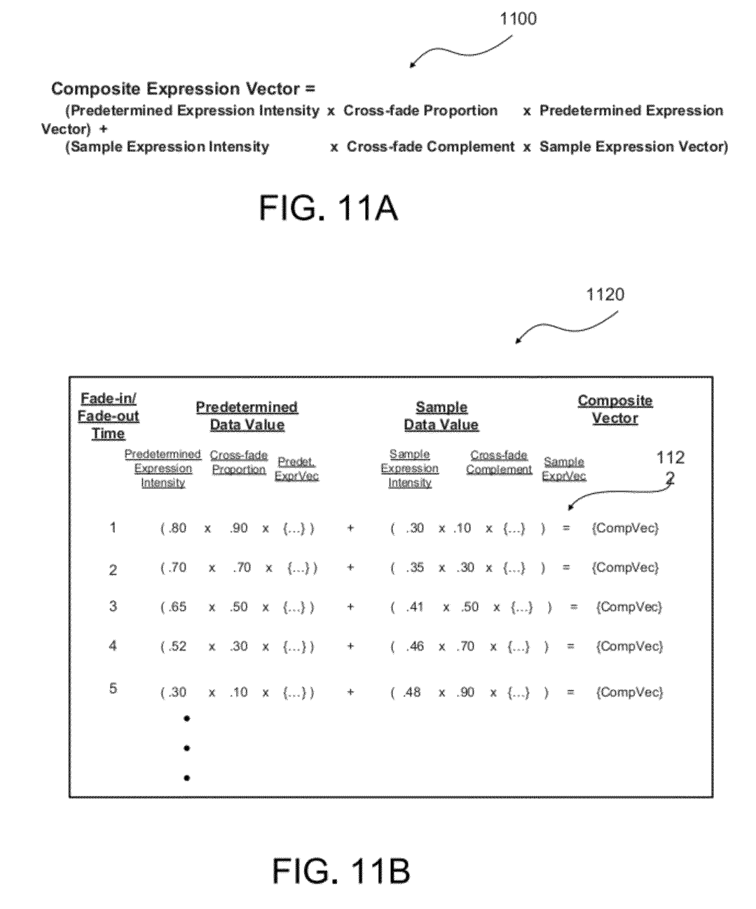

FIG. 11A illustrates one embodiment of an expression for computing a composite expression vector using equation 1100. A composite expression vector is a blended sum of two expression vectors at the same point in time corresponding to two data sets that are blended. At each point in time, composite expression vector may be calculated by multiplying predetermined expression vector, the expression vector corresponding to a point (or frame) of subject animation data, by a corresponding cross-fade proportion and multiplying the product by the predetermined expression intensity. This product may be further added to a product of sample expression vector, cross-fade complement, and sample expression intensity at the same point. The composite expression vector at each point represents a proportional amount of each expression vector from the subject animation data and the replacement animation data. The proportional amounts of the expression vectors change according to the cross-fade lines/curves as fade-in and fade-out time segments traversed (see FIGS. 9B, 9C, and 10). Equation 1100 may be used to obtain a linear combination of two sets of expression vectors corresponding to the subject animation data and the replacement animation data, respectively.

FIG. 11B is an embodiment of a computing sequence 1120 of composite expression vectors. Computing sequence 1120 is a numerical example showing the computation of the composite expression vector at each time step as fade-in and fade-out time segments are traversed. The expressions shown as “{ . . . }” represent corresponding expression vectors for subject animation data and replacement animation data. In each time-step 1-5 and further time-steps (not shown), a numerical expression 822 is computed according to equation 1100. The composite vectors resulting from this sequence of computations are used to determine the resultant animation data for the fade-in and/or fade-out time segments.

FIG. 12A illustrates one embodiment of a process of editing subject animation data using replacement animation data. In one embodiment, the process may be implemented within GRE 2512 of FIG. 2. Furthermore, process 1200 of FIG. 12 may be performed at least partially within block 610 of process 600 of FIG. 6.

The process of using the GRE for editing an animation sequence proceeds to block 1205, after a start block, where subject animation data are selected to be edited. The subject animation data may be obtained from various sources. For example, the subject animation data may be the result of a recording of a video game sequence such as described above in conjunction with process 600. It should be noted, that the editing may also be performed on virtually any of the recorded multi-dimensional game world data, including, but not limited to vehicles, animals, or the like.

The process proceeds to block 1210, where the replacement animation data are selected for blending with the selected subject animation data. The replacement animation data may be stored in a file or obtained from alternative sources, such as a remote server, or a third party animator, or the like.

The process proceeds to block 1215, where a time segment is selected within which the subject animation data is to be edited using the GRE. In one embodiment, the selected time segment may be surrounded on both sides by a fade-in and a fade-out time segment during which the blending of the subject animation data and replacement animation data is performed. The fade-in and fade-out time segments make the changes in the subject animation data during the selected time segment look gradual, rather than sudden and jerky. The process proceeds to block 1220.

At block 1220, the subject animation data are edited using the GRE. During the fade-in and fade-out time segments, composite expression vectors may be computed to blend the subject animation data with the replacement animation data according to cross-fade approach. However, as noted above, other blending mechanisms may also be used. During the selected time segment, outside the fade-in and fade-out time segments, the replacement animation data may be directly substituted for the subject animation data. After block 1220, the process may return to a calling process to perform other actions.

FIG. 12B is an embodiment of a process of computing composite expression vectors for editing of multi-dimensional game world data. At blocks 1230 and 1235, the subject animation data and animation sample expression vector sets are obtained corresponding to a selected time segment for performing editing. Each of the sets of expression vectors corresponding to the subject animation data and replacement animation data, respectively, may be obtained from various sources, as described above. For example, the subject animation data and corresponding subject expression vectors may be obtained from a recording of animation scenes, such as a video game sequence recording. The replacement animation data may be obtained from a file that has been prepared for editing. In one embodiment, the replacement animation data may be obtained from a library data store, or the like. In one embodiment, the expression vectors are linear and may be used with scalar multipliers to linearly adjust the intensity of a facial expression (or body pose or animation pattern) represented by the expression vectors.

The process proceeds to block 1240, where the fade-in (and/or fade-out) portion of the selected time segment is identified and/or selected. In one embodiment, fade-in time segment may be selected explicitly by specifying a starting point and ending point. Alternatively, the fade-in time segment may be specified by a starting point and length of time. In another embodiment, the fade-in (or fade-out) time segment may be specified as a leading (trailing) percentage of the selected time segment during which the subject animation data is to be edited.

The process proceeds to block 1245, where at blocks 1245 and 1250, cross-fade lines or curves may be used to determine the cross-fade proportion for each point in time during the fade-in (and/or fade-out) time segment. The vertical coordinates of the points on each of two or more cross-fade lines or curves may be used as scalar multipliers for the linear expression vectors corresponding to a next time point in the fade-in time segment. For example, the vertical coordinate of a first cross-fade line may be used to multiply an expression vector of the subject animation data, while the vertical coordinate of a second cross-fade line may be used to multiply an expression vector of the replacement animation data. The vertical coordinates of the points on the cross-fade lines or curves may be positive and/or negative numerical values or percentages.

The process proceeds to block 1255, where the obtained sets of expression vectors for the subject animation data and replacement animation data are blended together using the scalar multipliers obtained from the cross-fade lines and/or curves. In one embodiment, the subject animation data and replacement animation data are blended together according to expression 1100 of FIG. 11A. In another embodiment, other methods of blending the data may be used. For example, associative tables may be used to determine the proportions of each set of expression vectors to be blended together.

The process proceeds to decision block 1260, where it is determined whether more time points remain within the fade-in (and/or fade-out) time segment. If more time points remain, the process proceeds to block 1245, otherwise the process proceeds to block 1265.

At block 1265, in one embodiment, the subject animation data are replaced by the replacement animation data within the middle portion of the selected time segment without blending, saving computing resources, such as processing time and memory. At this point the process terminates.

Additionally, in at least one embodiment, the replacement animation data may be generated by a plurality of data sources, such as smoothed/sharpened/jittered versions of the original data, retimed versions of the original data, transformed versions of the original data, animated game presets and game animation sequences. Also, in at least one embodiment, blending towards a retimed version of the original data is different than blending towards a new timed sequence of data, since when blending towards a retimed version of the original data, data values are unchanged, but data times are changed. Furthermore, in at least one embodiment, falloff can be employed to blend the inputs to an operation on animation data instead of the outputs of the operation on animation data. For example, if a character is on an outer edge of a merry-go-round, and they are subsequently rotated ninety degrees around the center of the merry-go-round, from the north to the west, the fade-in and fade-out regions for the character's path blends into a straight line from their position at the north to their position at the west, if the results of the manipulation is blended. However, if instead the input to the manipulation was blended, (the angle of rotation) for the character instead rotates around the outside of the merry-go-round in the fade-in and fade-out regions.

It will be understood that each block of the flowchart illustrations discussed above, and combinations of blocks in the flowchart illustrations above, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor, provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A method of editing animation data with a network device, the method enabling actions, comprising:
identifying a plurality of components of video game world data for recording within the video game world;
executing a sequence of animation for the video game world for subsequent display in a plurality of video game frames, wherein the sequence includes at least one identified component;
recording the video game world data for at least one of the identified plurality of components that are generated by the execution of the sequence of animation prior to a rendering, recording and display of the plurality of video game frames;
selecting at least a portion of the video game frames and editing it's corresponding video game world data for at least one identified component, wherein editing includes:
selecting subject animation data to be edited from within the recorded video game world data;
selecting replacement animation data to use for editing the selected subject animation data;
selecting a time segment for replacing a portion of the subject animation data with at least a portion of the replacement animation data;
replacing the portion of the subject animation data with at least the portion of the replacement animation data within the time segment;
blending the subject animation data and the replacement animation data to transition between a remaining portion of the subject animation data and a replacement portion of the replacement animation data to create resultant animation data; and
providing the resultant animation data to a material system prior to a subsequent display of the plurality of video game frames that includes the resultant animation data.

2. The method of claim 1, wherein at least one of the subject animation data and the replacement animation data further comprises a plurality of frame data for video game world animation, each video game frame of the plurality of frame data including composite data for the video game frame.

3. The method of claim 1, further comprising blending the subject animation data and the replacement animation data further comprises using a spline interpolation to transition between the subject animation data and the replacement animation data.

4. The method of claim 1, wherein blending the subject animation data with the replacement animation data comprises using cross-fade lines to proportionally blend the subject animation data and the replacement animation data.

5. The method of claim 1, wherein blending the subject animation data with the replacement animation data comprises generating a linear combination of a first set of expression vectors corresponding to the subject animation data and a second set of expression vectors corresponding to the replacement animation data.

6. The method of claim 1, wherein at least one component of recorded video game world data is stored in at least one of a plurality of different data logs, wherein at least a portion of the different data logs correspond to at least one of the plurality of displayed video game frames.

7. The method of claim 1, wherein the video game world data comprises environment data, character data, physics data, game world motion data, sound data, event data, non-sampled parameter data, and timing data from the video game world and prior to submission to the material system.

8. A network device for editing animation data with a network device, the method enabling actions, comprising:
a memory configured to store data;
a processor that is operative to execute data that enables actions to be performed, comprising:
identifying a plurality of components of video game world data for recording within the video game world;
executing a sequence of animation for the video game world for subsequent display in a plurality of video game frames, wherein the sequence includes at least one identified component;
recording the video game world data for at least one of the identified plurality of components that are generated by the execution of the sequence of animation prior to a rendering, recording and display of the plurality of video game frames;
selecting at least a portion of the video game frames and editing it's corresponding video game world data for at least one identified component, wherein editing includes:
selecting subject animation data to be edited from within the recorded video game world data;
selecting replacement animation data to use for editing the selected subject animation data;
selecting a time segment for replacing a portion of the subject animation data with at least a portion of the replacement animation data;
replacing the portion of the subject animation data with at least the portion of the replacement animation data within the time segment;
blending the subject animation data and the replacement animation data to transition between a remaining portion of the subject animation data and a replacement portion of the replacement animation data to create resultant animation data; and
providing the resultant animation data to a material system prior to a subsequent display of the plurality of video game frames that includes the resultant animation data.

9. The device of claim 8, wherein at least one of the subject animation data and the replacement animation data further comprises a plurality of frame data for video game world animation, each video game frame of the plurality of frame data including composite data for the video game frame.

10. The device of claim 8, further comprising blending the subject animation data and the replacement animation data further comprises using a spline interpolation to transition between the subject animation data and the replacement animation data.

11. The device of claim 8, wherein blending the subject animation data with the replacement animation data comprises using cross-fade lines to proportionally blend the subject animation data and the replacement animation data.

12. The device of claim 8, wherein blending the subject animation data with the replacement animation data comprises generating a linear combination of a first set of expression vectors corresponding to the subject animation data and a second set of expression vectors corresponding to the replacement animation data.

13. The device of claim 8, wherein at least one component of recorded video game world data is stored in at least one of a plurality of different data logs, wherein at least a portion of the different data logs correspond to at least one of the plurality of displayed video game frames.

14. The device of claim 8, wherein the video game world data comprises environment data, character data, physics data, game world motion data, sound data, event data, non-sampled parameter data, and timing data from the video game world and prior to submission to the material system.

15. A processor readable non-transitory storage medium that includes data and instructions for editing animation data with a network device, wherein the execution of the instructions by a processor enables actions, comprising:
identifying a plurality of components of video game world data for recording within the video game world;
executing a sequence of animation for the video game world for subsequent display in a plurality of video game frames, wherein the sequence includes at least one identified component;
recording the video game world data for at least one of the identified plurality of components that are generated by the execution of the sequence of animation prior to a rendering, recording and display of the plurality of video game frames;
selecting at least a portion of the video game frames and editing it's corresponding video game world data for at least one identified component, wherein editing includes:
selecting subject animation data to be edited from within the recorded video game world data;
selecting replacement animation data to use for editing the selected subject animation data;
selecting a time segment for replacing a portion of the subject animation data with at least a portion of the replacement animation data;
replacing the portion of the subject animation data with at least the portion of the replacement animation data within the time segment;
blending the subject animation data and the replacement animation data to transition between a remaining portion of the subject animation data and a replacement portion of the replacement animation data to create resultant animation data; and
providing the resultant animation data to a material system prior to a subsequent display of the plurality of video game frames that includes the resultant animation data.

16. The medium of claim 15, wherein at least one of the subject animation data and the replacement animation data further comprises a plurality of frame data for video game world animation, each video game frame of the plurality of frame data including composite data for the video game frame.

17. The medium of claim 15, further comprising blending the subject animation data and the replacement animation data further comprises using a spline interpolation to transition between the subject animation data and the replacement animation data.

18. The medium of claim 15, wherein blending the subject animation data with the replacement animation data comprises using cross-fade lines to proportionally blend the subject animation data and the replacement animation data.

19. The medium of claim 15, wherein blending the subject animation data with the replacement animation data comprises generating a linear combination of a first set of expression vectors corresponding to the subject animation data and a second set of expression vectors corresponding to the replacement animation data.

20. The medium of claim 15, wherein at least one component of recorded video game world data is stored in at least one of a plurality of different data logs, wherein at least a portion of the different data logs correspond to at least one of the plurality of displayed video game frames.

21. The medium of claim 15, wherein the video game world data comprises environment data, character data, physics data, game world motion data, sound data, event data, non-sampled parameter data, and timing data from the video game world and prior to submission to the material system.

22. A system for editing animation data, comprising:
a first network device, including:
a first memory configured to store data;
a first display device;
a first processor that is operative to execute data that enables actions to be performed, comprising:
identifying a plurality of components of video game world data for recording within the video game world;
executing a sequence of animation for the video game world for subsequent display in a plurality of video game frames, wherein the sequence includes at least one identified component;
recording the video game world data for at least one of the identified plurality of components that are generated by the execution of the sequence of animation prior to a rendering, recording and display of the plurality of video game frames;
selecting at least a portion of the video game frames and editing it's corresponding video game world data for at least one identified component, wherein editing includes:
selecting subject animation data to be edited from within the recorded video game world data;
selecting replacement animation data to use for editing the selected subject animation data;
selecting a time segment for replacing a portion of the subject animation data with at least a portion of the replacement animation data;
replacing the portion of the subject animation data with at least the portion of the replacement animation data within the time segment;
blending the subject animation data and the replacement animation data to transition between a remaining portion of the subject animation data and a replacement portion of the replacement animation data to create resultant animation data;
providing the resultant animation data to a material system prior to a subsequent display of the plurality of video game frames that includes the resultant animation data; and
a second network device, including:
a second memory configured to store data;
a second display device;
a second processor that is operative to execute data that enables actions to be performed, comprising:
executing the video game world based at least in part on the resultant animation data; and
rendering and displaying the resultant animation data within at least a portion of the video game world that is played by a user.

23. The system of claim 22, wherein at least one of the subject animation data and the replacement animation data further comprises a plurality of frame data for video game world animation, each video game frame of the plurality of frame data including composite data for the video game frame.

24. The system of claim 22, further comprising blending the subject animation data and the replacement animation data further comprises using a spline interpolation to transition between the subject animation data and the replacement animation data.

25. The system of claim 22, wherein blending the subject animation data with the replacement animation data comprises using cross-fade lines to proportionally blend the subject animation data and the replacement animation data.

26. The system of claim 22, wherein blending the subject animation data with the replacement animation data comprises generating a linear combination of a first set of expression vectors corresponding to the subject animation data and a second set of expression vectors corresponding to the replacement animation data.

27. The system of claim 22, wherein at least one component of recorded video game world data is stored in at least one of a plurality of different data logs, wherein at least a portion of the different data logs correspond to at least one of the plurality of displayed video game frames.

28. The system of claim 22, wherein the video game world data comprises environment data, character data, physics data, game world motion data, sound data, event data, non-sampled parameter data, and timing data from the video game world and prior to submission to the material system.
